(19) United States
(12) Patent Application Publication
(10) Pub. No.: US 2025/0298238 A1
(43) Pub. Date: Sep. 25, 2025

(54) OPTICAL LAMINATE, LAMINATED OPTICAL FILM, OPTICAL ARTICLE, AND VIRTUAL REALITY DISPLAY DEVICE

(71) Applicant: FUJIFILM Corporation, Tokyo (JP)

(72) Inventors: Ryuji SANETO, Minamiashigara-shi (JP); Masamichi KISHINO, Minamiashigara-shi (JP); Katsumi SASATA, Minamiashigara-shi (JP); Naoyoshi YAMADA, Minamiashigara-shi (JP)

(73) Assignee: FUJIFILM Corporation, Tokyo (JP)

(21) Appl. No.: 19/228,771

(22) Filed: Jun. 5, 2025

Related U.S. Application Data
(63) Continuation of application No. PCT/JP2023/044019, filed on Dec. 8, 2023.

(30) Foreign Application Priority Data
Dec. 13, 2022 (JP) 2022-198779
Oct. 31, 2023 (JP) 2023-186933

(51) Int. Cl. G02B 27/00; G02B 5/08; G02B 5/30; G02B 27/28

(52) U.S. Cl. CPC G02B 27/0018; G02B 5/0825; G02B 5/3016; G02B 27/286

(57) ABSTRACT

An optical laminate including an adhesive layer, a light interference layer, and two or more laminated reflective layers in this order, in which the laminated reflective layer includes one reflective layer A that includes one or more cholesteric liquid crystal layers consisting of a rod-like liquid crystal, and one reflective layer B that includes one or more cholesteric liquid crystal layers consisting of a disk-like liquid crystal, in a case where the reflective layers A face each other or the reflective layers B face each other in adjacent laminated reflective layers, reflection center wavelengths of the adjacent reflective layers are different from each other.

### CROSS-REFERENCE TO RELATED APPLICATIONS

This application is a Continuation of PCT International Application No. PCT/JP2023/044019 filed on Dec. 8, 2023, which claims priority under 35 U.S.C. § 119(a) to Japanese Patent Application No. 2022-198779 filed on Dec. 13, 2022 and Japanese Patent Application No. 2023-186933 filed on Oct. 31, 2023. The above applications are hereby expressly incorporated by reference, in their entirety, into the present application.

### BACKGROUND OF THE INVENTION

### 1. Field of the Invention

The present invention relates to an optical laminate, a laminated optical film, an optical article, and a virtual reality display device.

### 2. Description of the Related Art

A reflective polarizer is a polarizer having a function of reflecting one polarized light in incidence ray and transmitting the other polarized light. Reflected light and transmitted light due to the reflective polarizer are in a polarization state of being orthogonal to each other. Here, the polarization state of being orthogonal to each other denotes a polarization state in which both light are positioned at antipodal points on the Poincare sphere, and for example, linearly polarized light orthogonal to each other, and clockwise circularly polarized light and counterclockwise circularly polarized light are in the corresponding state.

As a reflective linear polarizer in which transmitted light and reflected light are converted into linearly polarized light, for example, a film obtained by stretching a dielectric multilayer film as described in JP2011-053705A and a wire grid polarizer as described in JP2015-028656A are known.

In addition, as a reflective circular polarizer in which the transmitted light and the reflected light are converted into circularly polarized light, for example, a film having a light reflecting layer obtained by immobilizing a cholesteric liquid crystalline phase, as described in JP6277088B, has been known.

The reflective polarizer is used for the purpose of extracting only specific polarized light from incidence rays or separating incidence rays into two polarized light.

For example, in a liquid crystal display device, the reflective polarizer is used as a luminance-improving film which enhances light utilization efficiency by reflecting unnecessary polarized light from backlight and reusing the light. In addition, in a liquid crystal projector, the reflective polarizer is also used as a beam splitter which separates light from a light source into two linearly polarized light and supplies each of the two linearly polarized light to a liquid crystal panel.

In addition, in recent years, a method of using a reflective polarizer has been suggested for the purpose of generating a virtual image or a real image by partially reflecting external light and light from an image display device.

For example, JP2017-227720A discloses an in-vehicle room mirror which reflects light from behind using the reflective polarizer. Further, JP1995-120679A (JP-H7-120679A) discloses a method of generating a virtual image by reflecting light between a reflective polarizer and a half mirror to reciprocate the light in order to reduce the size and the thickness of a display unit in a virtual reality display device, an electronic finder, or the like.

### SUMMARY OF THE INVENTION

According to the examination conducted by the present inventors, it was found that in a case where a reflective polarizer partially reflects external light and light from an image display device to generate a virtual image or a real image, the sharpness of the image may be decreased in a case where any of the reflective polarizers of the related art described in JP2011-053705A, JP2015-028656A, and the like is used.

In contrast, it has been found that, by using a reflective circular polarizer having a light reflecting layer obtained by immobilizing a cholesteric liquid crystalline phase, favorable image sharpness is obtained. The present inventors have considered that the reason for this is that, since a reflective circular polarizer having a high polarization degree can be achieved with a thin film by having the light reflecting layer obtained by immobilizing a cholesteric liquid crystalline phase, it is less susceptible to influence of fluctuation due to foreign matter and due to coarseness and fineness of material distribution.

Furthermore, according to the studies by the present inventors, the virtual reality display device, the electronic finder, and the like utilize not only the reflected light but also the transmitted light, but in this case, it is important to suppress a ghost that is visually recognized as transmitted light which is originally desired to be cut is transmitted. In the reflective circular polarizer of the related art, disclosed in JP6277088B, suppression of the ghost is observed, and there is room for further improvement.

The present invention has been made in consideration of the above-described problems, and an object to be achieved by the present invention is to provide an optical laminate that can be used for a reflective circular polarizer with little occurrence of a ghost in a case of being used in a virtual reality display device, an electronic finder, and the like; a laminated optical film comprising the reflective circular polarizer; an optical article comprising the optical laminate; and a virtual reality display device including the optical article.

As a result of intensive studies repeatedly conducted by the present inventors on the above-described object, it has been found that the above-described object can be achieved by the following configurations.

[1] An optical laminate comprising:
an adhesive layer;
a light interference layer; and
two or more laminated reflective layers,
in which the laminated reflective layer includes
   one reflective layer A that includes at least one or more cholesteric liquid crystal layers formed of a first liquid crystal compound which substantially consists of a rod-like liquid crystal compound and that does not include a cholesteric liquid crystal layer formed of a second liquid crystal compound which substantially consists of a disk-like liquid crystal compound, and
   one reflective layer B that includes at least one or more cholesteric liquid crystal layers formed of the second liquid crystal compound which substantially consists of a disk-like liquid crystal compound and that does not include a cholesteric liquid crystal layer formed of the first liquid crystal compound which substantially consists of a rod-like liquid crystal compound,
among the two or more laminated reflective layers, in a case where reflective layers A face each other in two laminated reflective layers adjacent to each other in a lamination direction, central wavelengths of reflected light of the reflective layers A included in the two adjacent laminated reflective layers are different from each other,
among the two or more laminated reflective layers, in a case where reflective layers B face each other in two laminated reflective layers adjacent to each other in the lamination direction, central wavelengths of reflected light of the reflective layers B included in the two adjacent laminated reflective layers are different from each other,
the adhesive layer, the light interference layer, and the laminated reflective layers are adjacent to each other in this order,
in a case where a refractive index of the adhesive layer is nA and an average refractive index of one adjacent to the light interference layer out of the reflective layer A and the reflective layer B in the laminated reflective layer is nL, a refractive index nI of the light interference layer satisfies (nA×nL)^{1/2}−0.03≤nI≤(nA×nL)^{1/2}+0.03, and
a film thickness of the light interference layer is 60 nm to 110 nm or 230 nm to 330 nm.

[2] The optical laminate according to [1],
in which the reflective layer A and the reflective layer B are alternately arranged in the lamination direction of the optical laminate.

[3] The optical laminate according to [1],
in which a total number of the laminated reflective layers is 20 or less.

[4] The optical laminate according to [1],
in which a reflectivity of the optical laminate to light having a wavelength of 400 to 700 nm is 40% or more and less than 50%.

[5] The optical laminate according to [1],
in which the laminated reflective layer is configured such that the one reflective layer A and the one reflective layer B are in direct contact with each other, or configured such that the one reflective layer A and the one reflective layer B are arranged with an adhesion layer between the reflective layer A and the reflective layer B.

[6] The optical laminate according to any one of [1] to [5],
in which the light interference layer is a photo-alignment film.

[7] The optical laminate according to any one of [1] to [5],
in which the light interference layer is a C-plate.

[8] The optical laminate according to [7],
in which a compound having a cinnamoyl group is present between the C-plate and the laminated reflective layer.

[9] The optical laminate according to any one of [1] to [5],
in which the light interference layer is a hardcoat layer.

[10]A laminated optical film comprising, in the following order, at least:
a reflective circular polarizer;
a retardation layer which converts circularly polarized light into linearly polarized light; and
a linear polarizer,
in which the reflective circular polarizer is the optical laminate according to any one of [1] to [9].

[11] The laminated optical film according to [10],
in which the linear polarizer includes a light absorption anisotropic layer which contains at least a liquid crystal compound and a dichroic substance.

[12] The laminated optical film according to [10], further comprising:
a positive C-plate.

[13] The laminated optical film according to [10], further comprising:
an antireflection layer on a surface.

[14] The laminated optical film according to [13],
in which the antireflection layer is a moth-eye film or an AR film.

[15] The laminated optical film according to [10], further comprising:
a resin base material having a peak temperature of a loss tangent tan δ of 170° C. or lower.

[16] An optical article comprising:
the optical laminate according to any one of [1] to [9].

[17]A virtual reality display device comprising:
the optical article according to [16].

According to the present invention, it is possible to provide an optical laminate that can be used for a reflective circular polarizer with little occurrence of a ghost in a case of being used in a virtual reality display device, an electronic finder, and the like.

In addition, according to the present invention, it is possible to provide a laminated optical film comprising the reflective circular polarizer, an optical article comprising the optical laminate, and a virtual reality display device including the optical article.

### BRIEF DESCRIPTION OF THE DRAWINGS

FIG. 1 is a schematic diagram showing an example of an optical laminate according to a first embodiment of the present invention.

FIG. 2 is a schematic diagram showing an example of the optical laminate according to the first embodiment of the present invention.

FIG. 3 is an example of a virtual reality display device formed of a laminated optical film of the present invention.

FIG. 4 is an example of the virtual reality display device formed of the laminated optical film of the present invention.

FIG. 5 is a schematic diagram showing an example of the laminated optical film of the present invention.

FIG. 6 is a schematic diagram for describing an action of the optical laminate of the present invention.

FIG. 7 is a conceptual diagram for describing an action of the optical laminate in the related art.

### DESCRIPTION OF THE PREFERRED EMBODIMENTS

Hereinafter, the present invention will be described in detail. The description of the configuration requirements described below may be made based on representative embodiments and specific examples, but the present invention is not limited to such embodiments.

In addition, in the present specification, a numerical range shown using “to” indicates a range including numerical values described before and after “to” as a lower limit and an upper limit.

In the present specification, a term “orthogonal” does not denote 90° in a strict sense, but denotes 900±10°, preferably 900±5°. In addition, a term “parallel” does not denote 0° in a strict sense, but denotes 0°±10°, preferably 0°±5°. Furthermore, a term “45°” does not denote 45° in a strict sense, but denotes 450±10°, preferably 45°±5°.

In the present specification, a term “absorption axis” denotes a polarization direction in which absorbance is maximized in a plane in a case where linearly polarized light is incident. In addition, a term “reflection axis” denotes a polarization direction in which a reflectivity is maximized in a plane in a case where linearly polarized light is incident. In addition, a term “transmission axis” denotes a direction orthogonal to the absorption axis or the reflection axis in a plane. Furthermore, a term “slow axis” denotes a direction in which a refractive index is maximized in a plane. A term “fast axis” denotes a direction in which the refractive index is minimum in a plane, and is a direction orthogonal to the slow axis.

In the present specification, a retardation denotes an in-plane retardation unless otherwise specified, and is referred to as Re(λ). Here, Re(λ) represents an in-plane retardation at a wavelength a, and the wavelength k is 550 nm unless otherwise specified.

In addition, a retardation at the wavelength k in a thickness direction is referred to as Rth(λ) in the present specification. The wavelength k is set to 550 nm unless otherwise specified.

As Re(λ) and Rth(λ), values measured at the wavelength λ with AxoScan OPMF-1 (manufactured by Opto Science, Inc.) can be used. By inputting an average refractive index ((nx+ny+nz)/3) and a film thickness (d (μm)) in AxoScan,
a slow axis direction (∘)
Re(λ)=R0 (λ), and
“Rth(λ)=((nx+ny)/2−nz)×d” are calculated.

Examples of the optical laminate according to an embodiment of the present invention include the following first embodiment.

Hereinafter, the first embodiment of the optical laminate according to the embodiment of the present invention will be described.

### First Embodiment

An optical laminate according to the first embodiment of the present invention comprises:
two or more laminated reflective layers,
in which the laminated reflective layer includes
   one reflective layer A that includes at least one or more cholesteric liquid crystal layers (hereinafter, also referred to as a “liquid crystal layer 1”) formed of a first liquid crystal compound which substantially consists of a rod-like liquid crystal compound and that does not include a cholesteric liquid crystal layer (hereinafter, also referred to as a “liquid crystal layer 2”) formed of a second liquid crystal compound which substantially consists of a disk-like liquid crystal compound, and
   one reflective layer B that includes at least one or more liquid crystal layers 2 and that does not include the liquid crystal layer 1,
among the two or more laminated reflective layers, in a case where reflective layers A face each other in two laminated reflective layers adjacent to each other in a lamination direction, central wavelengths of reflected light of the reflective layers A included in the two adjacent laminated reflective layers are different from each other,
among the two or more laminated reflective layers, in a case where reflective layers B face each other in two laminated reflective layers adjacent to each other in the lamination direction, central wavelengths of reflected light of the reflective layers B included in the two adjacent laminated reflective layers are different from each other,
the adhesive layer, the light interference layer, and the laminated reflective layers are adjacent to each other in this order,
in a case where a refractive index of the adhesive layer is nA and an average refractive index of one adjacent to the light interference layer out of the reflective layer A and the reflective layer B in the laminated reflective layer is nL, a refractive index nI of the light interference layer satisfies (nA×nL)^{1/2}−0.03≤nI≤(nA×nL)^{1/2}+0.03, and
a film thickness of the light interference layer is 60 nm to 110 nm or 230 nm to 330 nm.

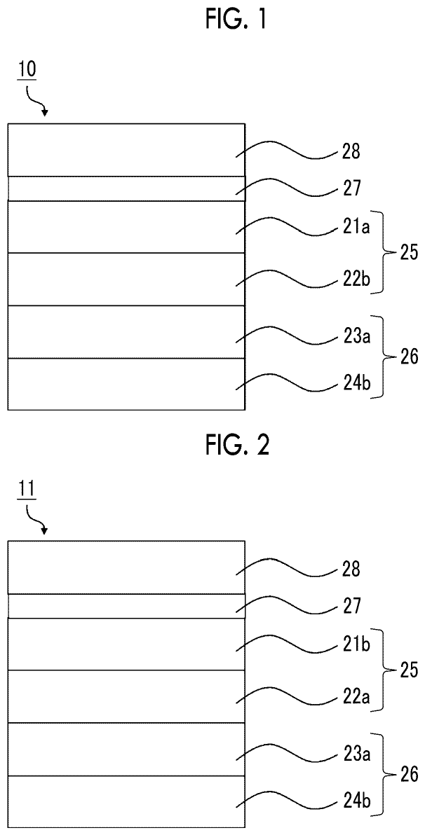

The optical laminate according to the first embodiment of the present invention will be described with reference to the accompanying drawing. FIG. 1 is a schematic cross-sectional diagram showing an example of a configuration of an optical laminate 10 according to the first embodiment.

In an aspect shown in FIG. 1, the optical laminate 10 is composed of a first laminated reflective layer 25, a second laminated reflective layer 26, a light interference layer 27, and an adhesive layer 28. The first laminated reflective layer 25 is composed of a reflective layer A 21a and a reflective layer B 22b, and the second laminated reflective layer 26 is composed of a reflective layer A 23a and a reflective layer B 24b. In the optical laminate 10 of the aspect shown in FIG. 1, the reflective layer A 21a, the reflective layer B 22b, the reflective layer A 23a, and the reflective layer B 24b are laminated in this order.

The optical laminate according to the first embodiment of the present invention can be used for a reflective circular polarizer. In a case where the optical laminate has the above-described configuration, since the reflective layer A has a positive Rth and the reflective layer B has a negative Rth, it is considered that the Rth's are canceled out, and occurrence of a ghost can be suppressed even for incidence ray from an oblique direction.

In addition, by setting the refractive index and the film thickness of the light interference layer to satisfy the above-described relationship, an antireflection effect at an interface between the first laminated reflective layer and the adhesive layer can be imparted. That is, as a result, it is possible to prevent circularly polarized light generated by the interface reflection from being changed in a rotation direction, for example, it is possible to prevent right circularly polarized light from being changed to left circularly polarized light by the interface reflection. Since the change in rotation direction of circularly polarized light caused by the interface reflection is one of the causes of the occurrence of the ghost, it is considered that the ghost can be prevented from occurring by suppressing the interface reflection. This point will be described below.

Hereinafter, the first embodiment according to the present invention will be described in detail.

### [Laminated Reflective Layer]

The optical laminate according to the first embodiment of the present invention includes two or more laminated reflective layers, in which the laminated reflective layer includes one reflective layer A and one reflective layer B described in detail later. That is, the optical laminate according to the first embodiment of the present invention includes two or more reflective layers A and two or more reflective layers B.

In the laminated reflective layer, the reflective layer A and the reflective layer B may be in direct contact with each other, or the reflective layer A and the reflective layer B may be laminated with other layers interposed therebetween. The other layers are not particularly limited, and examples thereof include an adhesion layer, a refractive index adjusting layer, a resin film, a positive C-plate, and an alignment layer. The adhesion layer is, for example, an adhesive layer, a pressure sensitive adhesive layer, and the like.

In addition, the laminated reflective layer may be configured such that one reflective layer A and one reflective layer B are in direct contact with each other, or may be configured such that one reflective layer A and one reflective layer B are arranged with an adhesion layer between the reflective layer A and the reflective layer B. Among these, it is preferable that the laminated reflective layer is configured such that one reflective layer A and one reflective layer B are in direct contact with each other.

In the optical laminate, the laminated reflective layers may be laminated such that the reflective layer A and the reflective layer B are alternately arranged, may be laminated such that the reflective layers A face each other, or may be laminated such that the reflective layers B face each other.

For example, in a case where the optical laminate according to the first embodiment includes two laminated reflective layers, the reflective layer A, the reflective layer B, the reflective layer A, and the reflective layer B may be laminated in this order; the reflective layer A, the reflective layer B, the reflective layer B, and the reflective layer A are laminated in this order; or the reflective layer B, the reflective layer A, the reflective layer A, and the reflective layer B are laminated in this order.

However, in a case where reflective layers A face each other in two laminated reflective layers adjacent to each other in a lamination direction, for example, in a case where the reflective layer B, the reflective layer A, the reflective layer A, and the reflective layer B are laminated in this order, the central wavelengths of reflected light of the reflective layers A included in the two laminated reflective layers adjacent to each other are different from each other. In addition, in a case where the reflective layers B face each other in two laminated reflective layers adjacent to each other in a lamination direction, for example, in a case where the reflective layer A, the reflective layer B, the reflective layer B, and the reflective layer A are laminated in this order, the central wavelengths of reflected light of the reflective layers B included in the two laminated reflective layers adjacent to each other are different from each other.

Hereinafter, an optical laminate in the case where the reflective layers A face each other in the two laminated reflective layers adjacent to each other in the lamination direction will be described with reference to the accompanying drawing.

An optical laminate 11 shown in FIG. 2 is composed of the first laminated reflective layer 25, the second laminated reflective layer 26, the light interference layer 27, and the adhesive layer 28. The first laminated reflective layer 25 is composed of a reflective layer B 21b and a reflective layer A 22a, and the second laminated reflective layer 26 is composed of the reflective layer A 23a and the reflective layer B 24b. In the optical laminate 11 of the aspect shown in FIG. 2, the reflective layer B 21b, the reflective layer A 22a, the reflective layer A 23a, and the reflective layer B 24b are laminated in this order.

However, in this optical laminate 11, the central wavelength of the reflected light of the reflective layer A 22a and the central wavelength of the reflected light of the reflective layer A 23a are different from each other. In addition, in the optical laminate 11 shown in FIG. 2, the reflective layer A 22a is included in the first laminated reflective layer 25, and the reflective layer A 23a is included in the second laminated reflective layer 26.

That is, as will be described in detail below, the reflective layer A may include two or more liquid crystal layers 1 in which central wavelengths of reflected light are different from each other, but in the optical laminate, in a case where two or more liquid crystal layers 1 are arranged in succession, the reflective layers A and the laminated reflective layers are configured such that the number of laminated reflective layers is maximized.

Similarly, as will be described in detail below, the reflective layer B may include two or more liquid crystal layers 2 in which central wavelengths of reflected light are different from each other, but in the optical laminate, in a case where two or more liquid crystal layers 2 are arranged in succession, the reflective layers B and the laminated reflective layers are configured such that the number of laminated reflective layers is maximized.

Among these aspects of the above-described lamination of the laminated reflective layers, an aspect in which the reflective layer A and the reflective layer B are laminated to be alternately arranged is preferable. That is, an aspect in which the reflective layer A and the reflective layer B are alternately arranged in a thickness direction of the optical laminate is preferable.

The optical laminate of the first embodiment includes two or more laminated reflective layers. Therefore, the optical laminate according to the embodiment of the present invention may include three laminated reflective layers or may include four or more laminated reflective layers. That is, the optical laminate may include two or more reflective layers A and two or more reflective layers B, may include three reflective layers A and three reflective layers B, or may include four or more reflective layers A and four or more reflective layers B.

The total number of the laminated reflective layers included in the optical laminate is preferably 30 or less, more preferably 20 or less, and still more preferably 10 or less. That is, the total number of the reflective layers A and the reflective layers B in the optical laminate is preferably 60 or less, more preferably 40 or less, and still more preferably 20 or less.

A thickness of the laminated reflective layer is preferably 0.2 μm or more, more preferably 0.4 μm or more, and still more preferably 0.6 μm or more. In addition, the thickness of the laminated reflective layer is preferably 20.0 μm or less, more preferably 14.0 μm or less, and still more preferably 10.0 μm or less.

The thickness of the laminated reflective layer can be measured by the same method as that for the reflective layer A and the reflective layer B, which will be described later.

Hereinafter, the reflective layer A and the reflective layer B will be described.

[Reflective layer A]

The laminated reflective layer included in the optical laminate according to the first embodiment of the present invention includes the reflective layer A which includes at least one or more liquid crystal layers 1 and does not include the liquid crystal layer 2.

The liquid crystal layer 1 is a cholesteric liquid crystal layer formed of a first liquid crystal compound which substantially consists of a rod-like liquid crystal compound, and the liquid crystal layer 1 substantially consists of the rod-like liquid crystal compound. The “cholesteric liquid crystal layer formed of a first liquid crystal compound which substantially consists of a rod-like liquid crystal compound” refers to a layer in which the first liquid crystal compound forms a cholesteric liquid crystalline phase and an alignment state of the cholesteric liquid crystalline phase is fixed. The above-described “substantially consists of a rod-like liquid crystal compound” means that an amount of the rod-like liquid crystal compound in the liquid crystal compound (first liquid crystal compound) contained in the liquid crystal layer 1 is 95% by mass or more. That is, the “first liquid crystal compound which substantially consists of a rod-like liquid crystal compound” means that a content of the rod-like liquid crystal compound is 95% by mass or more with respect to the total mass of the first liquid crystal compound. Among these, it is preferable that the first liquid crystal compound consists of only the rod-like liquid crystal compound.

In addition, the liquid crystal layer 2 is a cholesteric liquid crystal layer formed of a second liquid crystal compound which substantially consists of a disk-like liquid crystal compound, and the liquid crystal layer 2 substantially consists of the disk-like liquid crystal compound. The “cholesteric liquid crystal layer formed of a second liquid crystal compound which substantially consists of a disk-like liquid crystal compound” refers to a layer in which the second liquid crystal compound forms a cholesteric liquid crystalline phase and an alignment state of the cholesteric liquid crystalline phase is fixed. The above-described “substantially consists of a disk-like liquid crystal compound” means that an amount of the disk-like liquid crystal compound in the liquid crystal compound (second liquid crystal compound) contained in the liquid crystal layer 2 is 95% by mass or more. That is, the “second liquid crystal compound which substantially consists of a disk-like liquid crystal compound” means that a content of the disk-like liquid crystal compound is 95% by mass or more with respect to the total mass of the second liquid crystal compound. Among these, it is preferable that the second liquid crystal compound consists of only the disk-like liquid crystal compound.

It is sufficient that the reflective layer A includes one or more liquid crystal layers 1. Therefore, the reflective layer A may include two or more liquid crystal layers 1. In a case where the reflective layer A includes two or more liquid crystal layers 1, a layer other than the liquid crystal layer 2 may or may not be included between the two or more liquid crystal layers 1. The other layers are not particularly limited, and examples thereof include an adhesion layer (for example, an adhesive layer, a pressure sensitive adhesive layer, and the like), a refractive index adjusting layer, a resin film, a positive C-plate, and an alignment layer.

The number of liquid crystal layers 1 included in the reflective layer A is preferably 5 or less, more preferably 3 or less, and still more preferably 2 or less. The number of liquid crystal layers 1 included in the reflective layer A is also preferably one.

For example, in a case where two liquid crystal layers 1 have central wavelengths of reflected light, which are different from each other, the two liquid crystal layers 1 are regarded as two layers. In addition, in a case where central wavelengths of reflected light of two or more liquid crystal layers 1 are the same, for example, the two or more liquid crystal layers 1 are regarded as one layer even in a case of being formed by successive application or being separated by the above-described other layers.

In a case where the reflective layer A includes two or more liquid crystal layers 1, a central wavelength of reflected light of the reflective layer A is a central wavelength of reflected light of the entire reflective layer A. A method of measuring the central wavelength of the reflected light is as described below.

A thickness of the reflective layer A is preferably 0.1 μm or more, more preferably 0.2 μm or more, and still more preferably 0.3 μm or more. From the viewpoint that the ghost can be suppressed more, the thickness of the reflective layer A is preferably 10.0 μm or less, more preferably 7.0 μm or less, and still more preferably 5.0 μm or less.

The thickness of the reflective layer A can be measured by producing a cross section of the optical laminate and observing the cross section with a scanning electron microscope. The thickness of the reflective layer A is a value obtained by averaging thicknesses of the reflective layer A at any five points in the cross section of the optical laminate. In a case where the cross section of the optical laminate is observed with the scanning electron microscope, a region of the reflective layer A and a region of the reflective layer B, which will be described later, can be distinguished by a difference in contrast of a captured image. In addition, the reflective layer A and the reflective layer B can also be distinguished from each other by using composition analysis in a film thickness direction by time-of-flight secondary ion mass spectrometry (TOF-SIMS).

Rth of the reflective layer A at a wavelength of 550 nm is preferably 8 to 800 nm, more preferably 16 to 560 nm, and still more preferably 24 to 400 nm.

The Rth of the reflective layer A may be measured by taking out only the reflective layer A from the optical laminate, or may be measured by using Rth of a layer which is produced under the same conditions as those for producing the reflective layer A.

Examples of the rod-like liquid crystal compound contained in the liquid crystal layer 1 include known rod-like liquid crystal compounds, and preferred examples thereof include polymerizable rod-like liquid crystal compounds having a polymerizable group.

Examples of the rod-like liquid crystal compound are not particularly limited, and include those described in claim 1 of JP1999-513019A (JP-H11-513019A) or paragraphs [0026] of JP2005-289980A.

It is also preferable to use a liquid crystal compound having high refractive index anisotropy Δn (high Δn) as the rod-like liquid crystal compound. Here, Δn is a difference between a refractive index in the slow axis direction and a refractive index in the fast axis direction.

In a case where the rod-like liquid crystal compound has high Δn characteristics, a high reflectivity can be obtained even in a case where the number of turns of the helical structure of the cholesteric liquid crystalline phase is small, and thus desired reflection characteristics can be obtained even in a case of a thin film thickness. The magnitude of the retardation generated with respect to incidence light obliquely tilted from the normal direction of the cholesteric liquid crystal layer can be reduced due to the thinning, and as a result, the ghost can be further reduced.

The liquid crystal compound having a high refractive index anisotropy Δn is not particularly limited, but the compounds shown in paragraphs [0014] to [0029] of WO2019/182129A as an example and compounds represented by General Formula (I) can be preferably used.

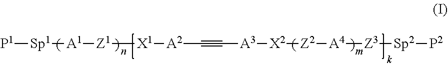

In General Formula (I), P¹ and P² each independently represent a hydrogen atom, —CN, —NCS, or a polymerizable group.

In General Formula (I), Sp¹ and Sp² each independently represent a single bond or a divalent linking group. However, Sp¹ and Sp² do not represent a divalent linking group including at least one group selected from the group consisting of an aromatic hydrocarbon ring group, an aromatic heterocyclic group, and an aliphatic hydrocarbon ring group.

In General Formula (I), Z¹, Z², and Z³ each independently represent a single bond, —O—, —S—, —CHR—, —CHRCHR—, —OCHR—, —CHRO—, —SO—, —SO₂—, —COO—, —OCO—, —CO—S—, —S—CO—, —O—CO—O—, —CO—NR—, —NR—CO—, —SCHR—, —CHRS—, —SO—CHR—, —CHR—SO—, —SO₂—CHR—, —CHR—SO₂—, —CF₂O—, —OCF₂—, —CF₂S—, —SCF₂—, —OCHRCHRO—, —SCHRCHRS—, —SO—CHRCHR—SO—, —SO₂—CHRCHR—SO₂—, —CH═CH—COO—, —CH═CH—OCO—, —COO—CH═CH—, —OCO—CH═CH—, —COO—CHRCHR—, —OCO—CHRCHR—, —CHRCHR—COO—, —CHRCHR—OCO—, —COO—CHR—, —OCO—CHR—, —CHR—COO—, —CHR—OCO—, —CR═CR—, —CR═N—, —N═CR—, —N═N—, —CR═N—N═CR—, —CF═CF—, or —C≡C—. R represents a hydrogen atom or an alkyl group having 1 to 10 carbon atoms. In a case where a plurality of R's are present, R's may be the same or different from each other. In a case where a plurality of Z's or a plurality of Z²'s are present, Z¹'s or Z²'s may be the same or different from each other. In a case where a plurality of Z³'s are present, Z³'s may be the same as or different from each other. Here, Z³ linked to SP² represents a single bond.

In General Formula (I), X¹ and X² each independently represent a single bond or S—. A plurality of X¹'s or a plurality of X²'s may be the same or different from each other. Here, among the plurality of X¹'s and a plurality of X²'s, at least one represents —S—. In General Formula (I), k represents an integer of 2 to 4.

In General Formula (I), m and n each independently represent an integer of 0 to 3. A plurality of m's may be the same or different from each other.

In General Formula (I), A¹, A², A³, and A⁴ each independently represent a group represented by any one of General Formulae (B-1) to (B-7) or a group where two or three groups among the groups represented by General Formulae (B-1) to (B-7) are linked. A plurality of A²'s or a plurality of A³'s may be the same or different from each other. A plurality of A's or a plurality of A⁴'s may be the same or different from each other.

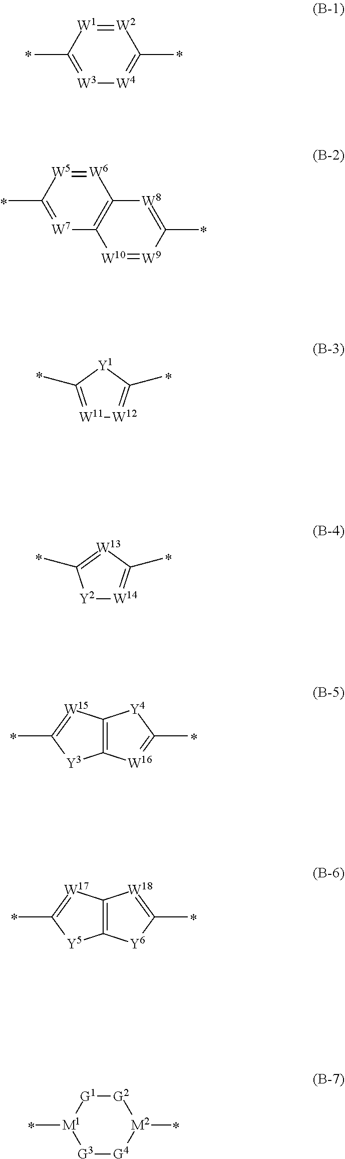

In General Formulae (B-1) to (B-7), W¹ to W¹⁸ each independently represent CR¹ or N, where R¹ represents a hydrogen atom or the following substituent L.

In General Formulae (B-1) to (B-7), Y¹ to Y⁶ each independently represent NR², O, or S, and R² represents a hydrogen atom or the following substituent L.

In General Formulae (B-1) to (B-7), G¹ to G⁴ each independently represent CR³R⁴, NRs, O, or S, and R³ to R⁵ each independently represent a hydrogen atom or the following substituent L.

In General Formulae (B-1) to (B-7), M¹ and M² each independently represent CR⁶ or N, and R⁶ represents a hydrogen atom or the following substituent L.
* represents a bonding position.

The substituent L represents an alkyl group having 1 to 10 carbon atoms, an alkoxy group having 1 to 10 carbon atoms, an alkylamino group having 1 to 10 carbon atoms, an alkylthio group having 1 to 10 carbon atoms, an alkanoyl group having 1 to 10 carbon atoms, an alkanoyloxy group having 1 to 10 carbon atoms, an alkanoylamino group having 1 to 10 carbon atoms, an alkanoylthio group having 1 to 10 carbon atoms, an alkyloxycarbonyl group having 2 to 10 carbon atoms, an alkylaminocarbonyl group having 2 to 10 carbon atoms, an alkylthiocarbonyl group having 2 to 10 carbon atoms, a hydroxy group, an amino group, a mercapto group, a carboxy group, a sulfo group, an amide group, a cyano group, a nitro group, a halogen atom, or a polymerizable group. Here, in a case where the group described as the substituent L has —CH₂—, a group in which at least one —CH₂— in the group is substituted with —O—, —CO—, —CH═CH—, or —C≡C— is also included in the substituent L. In addition, in a case where the group described as the substituent L has a hydrogen atom, a group in which at least one hydrogen atom in the group is substituted with at least one selected from the group consisting of a fluorine atom and a polymerizable group is also included in the substituent L.

In order to further reduce the ghost, the refractive index anisotropy Δn₅₅₀ (refractive index anisotropy at a wavelength of 550 nm) of the liquid crystal compound is preferably 0.12 or more, more preferably 0.16 or more, still more preferably 0.20 or more, and most preferably 0.25 or more.

From the viewpoint of suppressing interface reflection, the upper limit of Ansso (refractive index anisotropy at a wavelength of 550 nm) is preferably 0.90 or less, more preferably 0.70 or less, and still more preferably 0.50 or less.

In addition, it is sufficient that the liquid crystal layer 1 is a layer in which an alignment state of the rod-like liquid crystal compound forming the cholesteric liquid crystalline phase is maintained, and typically, the liquid crystal layer 1 can be formed by a method in which a polymerizable rod-like liquid crystal compound having a polymerizable group is aligned in a cholesteric liquid crystalline phase by adding a chiral agent or the like, and then polymerized and cured by ultraviolet irradiation, heating, and the like to form a layer without fluidity. It is sufficient that the liquid crystal layer 1 formed as described above is a layer which has changed to a form in which the alignment is not changed by an external field, an external force, or the like.

In the liquid crystal layer 1, it is sufficient that optical properties of the cholesteric liquid crystalline phase are maintained in the layer, and the rod-like liquid crystal compound in the liquid crystal layer 1 may not exhibit liquid crystal properties anymore. For example, the polymerizable rod-like liquid crystal compound may have high molecular weight due to the curing reaction, and may already lose liquid crystal properties.

A central wavelength k of the reflected light of the liquid crystal layer 1 depends on a pitch P of a helical structure (=the period of the helix) in the cholesteric liquid crystalline phase, and is expressed by a relationship of λ=n×P with an average refractive index n of the liquid crystal layer 1.

The central wavelength of the reflected light of the liquid crystal layer 1 can be obtained as follows. In a case where a transmission spectrum of the reflective layer A is measured from a normal direction of the liquid crystal layer 1 using a spectrophotometer UV3150 (manufactured by Shimadzu Corporation), a spectrum having a peak in which transmittance decreases is obtained in a region near the central wavelength of the reflected light. Among two wavelengths having a transmittance of ½ of the maximum peak value, in a case where a value of a wavelength on a shorter wavelength side is denoted by λ₁ (nm) and a value of a wavelength on a longer wavelength side is denoted by λₕ (nm), the central wavelength λ of the reflected light is determined by the following expression.

$$λ = ( {λ}_{1} + {λ}_{h} ) / 2$$

The pitch of the cholesteric liquid crystalline phase depends on the type of the chiral agent used together with the polymerizable rod-like liquid crystal compound and the addition concentration thereof, and a cholesteric liquid crystalline phase having a desired pitch can be obtained by adjusting one or more of the above. Regarding a helical turning direction and measuring method of the pitch, it is possible to use the method described on page 46 of “Liquid Crystal Chemical Experiment Introduction” edited by Japan Liquid Crystal Society, published by Sigma Corporation in 2007, and page 196 of “Liquid Crystal Handbook” Liquid Crystal Handbook Editing Committee, Maruzen Publishing Co., Ltd.

[Reflective layer B]

The laminated reflective layer included in the optical laminate according to the first embodiment of the present invention includes the reflective layer B which includes at least one or more liquid crystal layers 2 and does not include the liquid crystal layer 1.

Definitions of the liquid crystal layer 2 and the liquid crystal layer 1 are as described above.

It is sufficient that the reflective layer B includes one or more liquid crystal layers 2. Therefore, the reflective layer A may include two or more liquid crystal layers 2. In a case where the reflective layer B includes two or more liquid crystal layers 2, a layer other than the liquid crystal layer 1 may or may not be included between the two or more liquid crystal layers 2. The other layers are not particularly limited, and examples thereof include an adhesion layer (for example, an adhesive layer, a pressure sensitive adhesive layer, and the like), a refractive index adjusting layer, a resin film, a positive C-plate, and an alignment layer.

The number of liquid crystal layers 2 included in the reflective layer B is preferably 5 or less, more preferably 3 or less, and still more preferably 2 or less. The number of liquid crystal layers 2 included in the reflective layer B is also preferably one.

For example, in a case where two liquid crystal layers 2 have central wavelengths of reflected light, which are different from each other, the two liquid crystal layers 2 are regarded as two layers. In addition, in a case where central wavelengths of reflected light of two or more liquid crystal layers 2 are the same, for example, the two or more liquid crystal layers 2 are regarded as one layer even in a case of being formed by successive application or being separated by the above-described other layers.

In a case where the reflective layer B includes two or more liquid crystal layers 2, a central wavelength of reflected light of the reflective layer B is a central wavelength of reflected light of the entire reflective layer B. The measurement of the central wavelength of the reflected light of each liquid crystal layer 2 is carried out according to the above-described measuring method of the central wavelength of the reflected light of the liquid crystal layer 1.

A thickness of the reflective layer B is preferably 0.1 μm or more, more preferably 0.2 μm or more, and still more preferably 0.3 μm or more. From the viewpoint that the ghost can be suppressed more, the thickness of the reflective layer B is preferably 10.0 μm or less, more preferably 7.0 μm or less, and still more preferably 5.0 μm or less.

The thickness of the reflective layer B can be measured by producing a cross section of the optical laminate and observing the cross section with a transmission electron microscope.

Rth of the reflective layer B at a wavelength of 550 nm is preferably −800 to −8 nm, more preferably −560 to −16 nm, and still more preferably −400 to −24 nm. The Rth of the reflective layer B may be measured by taking out only the reflective layer B from the optical laminate, or may be measured by using Rth of a layer which is produced under the same conditions as those for producing the reflective layer B.

The disk-like liquid crystal compound contained in the above-described liquid crystal layer 2 is not particularly limited, and a known disk-like liquid crystal compound can be used. As an example, as the disk-like liquid crystal compound, the disk-like liquid crystal compounds described in paragraphs [0020] to [0122] of JP2007-108732A can be suitably used.

In addition, it is also preferable to use a liquid crystal compound having high refractive index anisotropy Δn (high Δn) as the disk-like liquid crystal compound. Here, Δn is a difference between a refractive index in the slow axis direction and a refractive index in the fast axis direction.

In a case where the disk-like liquid crystal compound has high Δn characteristics, a high reflectivity can be obtained even in a case where the number of turns of the helical structure of the cholesteric liquid crystalline phase is small, and thus desired reflection characteristics can be obtained even in a case of a thin film thickness. The magnitude of the retardation generated with respect to incidence light obliquely tilted from the normal direction of the cholesteric liquid crystal layer can be reduced due to the thinning, and as a result, the ghost can be further reduced. As the disk-like compound having a high Δn, for example, the disk-like liquid crystal compounds described in paragraphs [0012] to [0108] of JP2010-244038A can be suitably used.

In order to further reduce the ghost, the refractive index anisotropy Δn₅₅₀ (refractive index anisotropy at a wavelength of 550 nm) of the liquid crystal compound is preferably 0.12 or more, more preferably 0.16 or more, still more preferably 0.20 or more, and most preferably 0.25 or more.

From the viewpoint of suppressing interface reflection, the upper limit of Ansso (refractive index anisotropy at a wavelength of 550 nm) is preferably 0.90 or less, more preferably 0.70 or less, and still more preferably 0.50 or less.

In addition, it is sufficient that the liquid crystal layer 2 is a layer in which an alignment state of the disk-like liquid crystal compound forming the cholesteric liquid crystalline phase is maintained, and typically, the liquid crystal layer 2 can be formed by a method in which a polymerizable disk-like liquid crystal compound having a polymerizable group is aligned in a cholesteric liquid crystalline phase by adding a chiral agent or the like, and then polymerized and cured by ultraviolet irradiation, heating, and the like to form a layer without fluidity. It is sufficient that the liquid crystal layer 2 formed as described above is a layer which has changed to a form in which the alignment is not changed by an external field, an external force, or the like.

In the liquid crystal layer 2, it is sufficient that optical properties of the cholesteric liquid crystalline phase are maintained in the layer, and the disk-like liquid crystal compound in the liquid crystal layer 2 may not exhibit liquid crystal properties anymore. For example, the polymerizable disk-like liquid crystal compound may have high molecular weight due to the curing reaction, and may already lose liquid crystal properties.

A central wavelength k of the reflected light of the liquid crystal layer 2 depends on a pitch of a helical structure in the cholesteric liquid crystalline phase, and can be defined in the same manner as in the case of the liquid crystal layer 1 and can be measured by the same method.

The pitch of the cholesteric liquid crystalline phase depends on the type of the chiral agent used together with the polymerizable disk-like liquid crystal compound and the addition concentration thereof, and a cholesteric liquid crystalline phase having a desired pitch can be obtained by adjusting one or more of the above. Regarding a helical turning direction and measuring method of the pitch, the above-described documents can be referred to.

In addition, the pitch of the cholesteric liquid crystalline phase may change in the film thickness direction. A state in which the pitch changes in the film thickness direction is referred to as a pitch gradient, and a layer in which the pitch changes in the film thickness direction is referred to as a pitch gradient layer. The pitch gradient layer can be produced using a known method, and for example, JP2020-060627A and the like can be referred to.

In the pitch gradient layer, since the helical pitch changes in the film thickness direction, light in a plurality of wavelength ranges can be reflected.

### [Reflectivity]

A reflectivity of the optical laminate according to the first embodiment of the present invention to light having a wavelength of 400 to 700 nm is preferably 40% or more and less than 50%. In a case where the above-described reflectivity is 40% or more, the ghost is more easily suppressed. The light having a wavelength of 400 to 700 nm refers to unpolarized light.

The reflectivity of the optical laminate to the light having a wavelength of 400 to 700 nm is measured under the following conditions.

An automated absolute reflectance measurement system including an ultraviolet-visible-near infrared spectrophotometer V-750 manufactured by JASCO Corporation is used for the measurement. S-wave and P-wave polarized light having a wavelength of 350 to 900 nm are incident on the optical laminate at an incidence angle of 5°. Absolute reflectivity with respect to each of the S-wave and the P-wave is measured, and an average value thereof is calculated for each wavelength to obtain a reflection spectrum. From the obtained reflectivity spectrum, an average reflectivity to the light having a wavelength of 400 to 700 nm is calculated and used as the reflectivity of the optical laminate to the light having a wavelength of 400 to 700 nm.

[Types and arrangement of reflective layer A and reflective layer B]

The optical laminate according to the first embodiment of the present invention includes the reflective layer A and the reflective layer B.

Here, the optical laminate preferably includes at least a blue light reflecting layer having a reflectivity of 40% or more at a wavelength of 460 nm, a green light reflecting layer having a reflectivity of 40% or more at a wavelength of 550 nm, a yellow light reflecting layer having a reflectivity of 40% or more at a wavelength of 600 nm, and a red light reflecting layer having a reflectivity of 40% or more at a wavelength of 650 nm. Each of the blue light reflecting layer, the green light reflecting layer, the yellow light reflecting layer, and the red light reflecting layer described above may correspond to any of the reflective layer A or the reflective layer B.

For example, in a case where the reflective layer A corresponds to the blue light reflecting layer, the central wavelength of the reflected light of the reflective layer A may be adjusted by the above-described method to set the central wavelength of the reflected light to approximately 460 nm. In addition, in a case where the reflective layer B corresponds to the blue light reflecting layer, the central wavelength of the reflected light of the reflective layer B may be adjusted by the above-described method to set the central wavelength of the reflected light to approximately 460 nm. The above-described reflectivity is a reflectivity in a case where non-polarized light is incident on the reflective layer at each wavelength.

In a case where the optical laminate includes the blue light reflecting layer, the green light reflecting layer, the yellow light reflecting layer, and the red light reflecting layer described above, the optical laminate may include two or more blue light reflecting layers, two or more green light reflecting layers, two or more yellow light reflecting layers, or two or more red light reflecting layers.

The central wavelength of the reflected light of the blue light reflecting layer is preferably in a range of 430 nm or more and less than 500 nm.

The central wavelength of the reflected light of the green light reflecting layer is preferably in a range of 500 nm or more and less than 570 nm.

The central wavelength of the reflected light of the yellow light reflecting layer is preferably in a range of 570 nm or more and less than 620 nm.

The central wavelength of the reflected light of the red light reflecting layer is preferably in a range of 620 nm or more and less than 670 nm.

A method of measuring the central wavelength of the reflected light is as described above.

In addition, in the optical laminate according to the first embodiment of the present invention, the central wavelengths of the reflected light of the reflective layer A and the reflective layer B included in the optical laminate may be adjusted so that the reflectivity is 40% or more over the entire visible light region (wavelength of 400 to 700 nm).

In addition, in the optical laminate, it is also preferable that the blue light reflecting layer, the green light reflecting layer, the yellow light reflecting layer, and the red light reflecting layer described above are laminated in this order.

In addition, in a case where the optical laminate having the above-described lamination order is applied to a reflective circular polarizer described later, in the reflective layer on the long wavelength side (for example, in the red light reflecting layer), the thickness of the reflective layer required to obtain sufficient reflectivity increases, and Rth of the reflective layer itself has a greater effect on light transmitted through the reflective layer. From this viewpoint, it is preferable that a reflective layer arranged on a light source side is the reflective layer on the short wavelength side (for example, the blue light reflecting layer).

In the optical laminate according to the first embodiment of the present invention, it has been described that, since the reflective layer A has a positive Rth and the reflective layer B has a negative Rth, the Rth's are canceled out, and the details thereof will be described below.

In an optical laminate including n reflective layers, in a case where the reflective layers are named L₁, L₂, L₃, . . . , and Lₙ (n is an integer of 4 or more) from a light source side, the sum of Rth of each layer from the reflective layer L₁ to the reflective layer L₁ (i is an integer of n or less) is denoted by SRthᵢ. Specifically, the SRthᵢ is expressed as follows.

$${SRth}_{1} = {Rth}_{1}$$

$${SRth}_{2} = {Rth}_{1} + {Rth}_{2}$$

$$…$$

$${SRth}_{i} = {Rth}_{1} + {Rth}_{2} + … + {Rth}_{i}$$

$$…$$

$${SRth}_{n} = {Rth}_{1} + {Rth}_{2} + … + {Rth}_{i} + … + {Rth}_{n}$$

Absolute values of all of SRthᵢ (SRth₁ to SRthₙ) are each preferably 0.3 μm or less, more preferably 0.2 μm or less, and still more preferably 0.1 μm or less. The Rthᵢ of each layer in the above-described expression is determined by the expression for calculating Rth described above.

It is considered that, by setting the SRthᵢ to be within the above-described preferred range, a retardation which occurs in a case where light is transmitted through each reflective layer can be reduced, and the occurrence of the ghost can be further suppressed even for incidence ray from an oblique direction.

In addition, in a case where the laminated reflective layer is configured such that the reflective layer A and the reflective layer B are in direct contact with each other, in order to reduce a difference in refractive index, it is preferable that the reflective layer A and the reflective layer B are arranged such that an alignment direction (slow axis direction) of the liquid crystal compound (the rod-like liquid crystal compound or the disk-like liquid crystal compound) changes continuously at an interface. For the above-described arrangement, for example, in a case where the reflective layer A is formed on the reflective layer B, a coating liquid containing a rod-like liquid crystal compound is directly applied on the reflective layer B, and the slow axis direction can be aligned while continuous changing at the interface by alignment regulating force of the disk-like liquid crystal compound contained in the reflective layer B.

A thickness of the optical laminate according to the first embodiment of the present invention is preferably 30 μm or less and more preferably 15 μm or less.

The lower limit thereof is not particularly limited, but is, for example, 1 μm or more, preferably 5 μm or more.

A manufacturing method of the optical laminate according to the first embodiment of the present invention, a laminated optical film formed using the optical laminate, and the like will be described later.

[Light interference layer]

The optical laminate according to the embodiment of the present invention includes a light interference layer. The refractive index of the light interference layer satisfies the following conditions.

That is, in a case where the refractive index of the adhesive layer adjacent to the light interference layer is nA and the average refractive index of one adjacent to the light interference layer out of the reflective layer A and the reflective layer B in the laminated reflective layer is nL, a refractive index nI of the light interference layer satisfies

$${( nA \times nL )}^{1 / 2} - 0.03 \leq nI \leq {( nA \times nL )}^{1 / 2} + 0.03 .$$

In the optical laminate 10 shown in FIG. 1, the refractive index nA of the adhesive layer 28, the average refractive index nL of the reflective layer A 21a, and the refractive index nI of the light interference layer 27 satisfy the above-described relationship.

It is preferable that the refractive index nA of the adhesive layer adjacent to the light interference layer, the average refractive index nL of one adjacent to the light interference layer out of the reflective layer A and the reflective layer B in the laminated reflective layer, and the refractive index nI of the light interference layer

$$preferably satisfy {( nA \times nL )}^{1 / 2} - 0.02 \leq nI \leq {( nA \times nL )}^{1 / 2} + 0.02 , and$$

$$more preferably {satisfy ( nA \times nL )}^{1 / 2} - 0.01 \leq nI \leq {( nA \times nL )}^{1 / 2} + 0.01 .$$

In the laminated reflective layer, either the reflective layer A or the reflective layer B may be adjacent to the light interference layer. “The average refractive index of one adjacent to the light interference layer out of the reflective layer A and the reflective layer B in the laminated reflective layer is nL” means that the average refractive index of the reflective layer A is nL in a case where the reflective layer A is adjacent to the light interference layer, and the average refractive index of the reflective layer B is nL in a case where the reflective layer B is adjacent to the light interference layer.

By setting the refractive index of the light interference layer in this range, the amplitude reflectivity on both surfaces of the light interference layer can be made to be the same magnitude. Therefore, it is considered that a large antireflection effect can be obtained.

That is, in a case where the optical laminate does not include the light interference layer, the reflective layer and the adhesive layer of the laminated reflective layer are adjacent to each other. In the optical laminate 10 shown in FIG. 1, the reflective layer A 21a and the adhesive layer 28 are adjacent to each other. At the interface between the two layers, reflection at the interface occurs depending on the difference in refractive index.

For example, in a case where the cholesteric liquid crystal layer (reflective layer) of the laminated reflective layer reflects right circularly polarized light, in a case where left circularly polarized light unnecessarily transmits through the laminated reflective layer, this light is converted into a ghost. Specifically, in a case where the right circularly polarized light is incident from the adhesive layer side, the reflective layer configuring the laminated reflective layer reflects the right circularly polarized light to the adhesive layer side. In this case, a part of the right circularly polarized light reflected from the reflective layer (cholesteric liquid crystal layer) is reflected from the interface between the reflective layer and the adhesive layer of the laminated reflective layer. During this reflection, the right circularly polarized light is converted into left circularly polarized light. As described above, the reflective layer (cholesteric liquid crystal layer) of the laminated reflective layer reflects right circularly polarized light, and thus transmits left circularly polarized light. The unnecessary transmitted left circularly polarized light is converted into a ghost.

On the other hand, the optical laminate according to the embodiment of the present invention includes the above-described light interference layer having the above-described refractive index between the laminated reflective layer and the adhesive layer. The optical laminate according to the embodiment of the present invention includes such a light interference layer, and thus the difference in refractive index at the interface of a layer present between the laminated reflective layer and the adhesive layer can be reduced. Specifically, the optical laminate according to the embodiment of the present invention includes such a light interference layer, and thus the difference in refractive index between the reflective layer adjacent to the light interference layer and the light interference layer and the difference in refractive index between the light interference layer and the adhesive layer can be reduced.

As a result, the optical laminate according to the embodiment of the present invention can reduce the interface reflection at the interface present between the reflective layer and the adhesive layer, and it is possible to prevent circularly polarized light generated by the interface reflection from being changed in a rotation direction, for example, it is possible to prevent right circularly polarized light from being changed to left circularly polarized light by the interface reflection. Since the change in rotation direction of circularly polarized light caused by the interface reflection is one of the causes of the occurrence of the ghost, it is considered that the ghost can be prevented from occurring by suppressing the interface reflection.

The above points will be described in detail below with the virtual reality display device as an example.

Each refractive index of the light interference layer, the reflective layer, and the adhesive layer can be measured with reference to the method described in Examples.

In addition, in the present invention, the refractive index of each layer refers to, without exception, a refractive index in light having a wavelength of 550 nm.

In the optical laminate according to the embodiment of the present invention, the film thickness of the light interference layer is in a range of 60 to 110 nm or 230 to 330 nm.

As described above, in the optical laminate according to the embodiment of the present invention, since the difference in refractive index between the reflective layer adjacent to the light interference layer in the laminated reflective layer and the light interference layer and the difference in refractive index between the light interference layer and the adhesive layer are small, reflection at this interface can be reduced. However, even between the both interfaces, a small amount of interface reflection occurs. On the other hand, in the optical laminate according to the embodiment of the present invention, by setting the film thickness of the light interference layer to be in the above-described range, the phases of reflected light at both interfaces can be suitably shifted, and the reflected light at both interfaces can cancel each other out. As a result, ghosts caused by the reflection of unnecessary light at the interface can be further reduced.

The virtual reality image display device will be described in detail below as an example with respect to the above points.

The film thickness of the light interference layer is preferably in a range of 75 to 100 nm or 245 to 300 nm, and more preferably in a range of 80 to 95 nm or 260 to 285 nm.

The material for forming the light interference layer is not limited, and various known materials can be used as long as a refractive index nI satisfying “(nA×nL)^{1/2}−0.03≤nI≤(nA×nL)^{1/2}+0.03” can be obtained.

Specifically, as a material for forming the light interference layer, a hardcoat material in which a monomer is crosslinked, a photo-alignment film, and a C-plate using a liquid crystal material can be used.

Among these, the C-plate can also play a role in optical compensation adjustment, and thus is more preferable. Furthermore, a positive C-plate is more preferable. Here, the positive C-plate is a retardation layer in which the Re is substantially zero and the Rth has a negative value. The positive C-plate can be obtained, for example, by vertically aligning rod-like liquid crystal compounds. With regard to the details of the method for manufacturing the positive C-plate, reference can be made to the description in, for example, JP2017-187732A, JP2016-053709A, JP2015-200861A, and the like.

The positive C-plate functions as an optical compensation layer for increasing the polarization degree of the transmitted light with respect to light incident obliquely. The positive C-plates can be provided at any position of the laminated optical film, and a plurality of the positive C-plates may be provided. In this case, Re(550) of the C-plate is preferably approximately 10 nm or less, and Rth(550) is preferably −100 to −1 nm and more preferably −30 to −5 nm.

[Material for interlayer photo-alignment film]

Here, in the present invention, it is preferable that a material for an interlayer photo-alignment film is present between the light interference layer and the laminated reflective layer. The material for an interlayer photo-alignment film may be included in the light interference layer.

As a result, in a case where the liquid crystal material is applied to the light interference layer, the liquid crystal compound can be aligned, and a structure in which the light interference layer and the reflective layer are adjacent to each other can be formed.

As the material for an interlayer photo-alignment film, for example, a photo-alignment polymer described in JP2021-143336A can be used.

The material for an interlayer photo-alignment film is preferably a compound having a cinnamoyl group. In particular, in a case where the light interference layer is a C-plate, it is preferable that a compound having a cinnamoyl group, that is, a cinnamoyl compound is present between the light interference layer and the laminated reflective layer. That is, the cinnamoyl compound is preferably present in a region near a boundary between the light interference layer (preferably, the C-plate) and the laminated reflective layer.

[Hardcoat layer]

The hardcoat layer is not particularly limited as long as the above-described requirements for nI are satisfied, and a known hardcoat layer can be used.

Examples of a method of forming the hardcoat layer include a method of forming a coating layer by coating the outermost cholesteric liquid crystal layer with a curable composition containing a crosslinkable monomer and curing the formed coating layer to form a hardcoat layer.

Examples of the crosslinkable monomer contained in the curable composition include a monomer having a crosslinkable group. The crosslinkable group is not particularly limited, and examples thereof include a radically polymerizable group and a cationically polymerizable group.

The radically polymerizable group is not particularly limited, and examples thereof include a vinyl group, a butadiene group, a (meth)acryloyl group, a (meth)acrylamide group, a vinyl acetate group, a fumaric acid ester group, a styryl group, a vinylpyrrolidone group, and a maleimide group, where a (meth)acryl group is preferable. The (meth)acryloyl group represents a concept including an acryloyl group and a methacryloyl group.

The cationically polymerizable group is not particularly limited, and examples thereof include a vinyl ether group, an epoxy group, and an oxetanyl group.

The monomer having a crosslinkable group may be used alone or in combination of two or more kinds thereof.

In addition, the curable composition may contain the polymerization initiator. As the polymerization initiator, a known polymerization initiator such as a photopolymerization initiator and a thermal polymerization initiator can be applied.

The refractive index of the hardcoat layer can be adjusted by, for example, the refractive index of the crosslinkable monomer contained in the curable composition.

For example, by using a crosslinkable monomer having an aromatic ring or the like in the molecule as the crosslinkable monomer, the refractive index of the hardcoat layer can be increased. On the other hand, by using a crosslinkable monomer having no aromatic ring or the like in the molecule as the crosslinkable monomer, the refractive index of the hardcoat layer can be reduced.

In addition, the refractive index of the hardcoat layer can be adjusted by mixing the curable composition with inorganic oxide fine particles.

[Photo-alignment film]

As the light interference layer, a so-called photo-alignment film (photo-alignment layer) obtained by irradiating a photo-alignable material with polarized light or non-polarized light to form an alignment layer is also a preferable aspect.

It is preferable to impart an alignment regulating force to the photo-alignment film by a step of radiating polarized light from a vertical direction or an oblique direction, or a step of radiating non-polarized light from an oblique direction.

By using the photo-alignment film, it is possible to horizontally align the specific liquid crystal compounds with excellent symmetry. Therefore, the retardation layer positive A-plate formed by using the photo-alignment film is particularly useful for optical compensation in a liquid crystal display device which does not require a pre-tilt angle of a drive liquid crystal, such as a liquid crystal display device in an in-place-switching (IPS) mode.

Examples of the photo-alignable material used in the photo-alignment film include: an azo compound described in JP2006-285197A, JP2007-076839A, JP2007-138138A, JP2007-094071A, JP2007-121721A, JP2007-140465A, JP2007-156439A, JP2007-133184A, JP2009-109831A, JP3883848B, and JP4151746B; an aromatic ester compound described in JP2002-229039A; a maleimide- and/or alkenyl-substituted nadiimide compound having a photo-alignable unit described in JP2002-265541A and JP2002-317013A; a photocrosslinking silane derivative described in JP4205195B and JP4205198B, a photocrosslinking polyimide, a polyamide, or an ester described in JP2003-520878A, JP2004-529220A, and JP4162850B; and a photodimerizable compound, in particular, a cinnamate compound, a chalcone compound, or a coumarin compound described in JP1997-118717A (JP-H09-118717A), JP1998-506420A (JP-H10-506420A), JP2003-505561A, WO2010/150748A, JP2013-177561A, and JP2014-012823A.

Particularly preferred examples of the photo-alignment material include the azo compound, the photocrosslinkable polyimide, the polyamide, the ester, the cinnamate compound, and the chalcone compound.

[Adhesive layer]

The optical laminate according to the embodiment of the present invention includes an adhesive layer.

This adhesive layer is used for bonding the optical laminate according to the embodiment of the present invention to any optical member (optical component). For example, in a case where the optical laminate according to the embodiment of the present invention is used as a reflective circular polarizer of a virtual reality display device described later, the optical laminate according to the embodiment of the present invention is bonded to a lens of an optical system (pancake lens) constituting the virtual reality display device by an adhesive layer.

As the adhesive layer, a known adhesive and pressure sensitive adhesive can be appropriately used as long as the adhesive layer has a refractive index satisfying the above relational expression. As an example, an adhesive and a pressure sensitive adhesive used in a laminated optical film described later can be appropriately used.

The thickness of the adhesive layer is not limited, and a thickness at which a required bonding force can be obtained may be appropriately set according to the material for forming the adhesive layer.

[Manufacturing method of optical laminate]

The optical laminate according to the embodiment of the present invention (the first embodiment) can be manufactured by a known method, and the method is not particularly limited.

For example, examples of a manufacturing method according to the first embodiment include a method in which a first cholesteric liquid crystal layer is formed by applying a composition containing a rod-like liquid crystal compound onto a base material, forming a cholesteric liquid crystalline phase, and immobilizing an alignment state of the cholesteric liquid crystalline phase, a second cholesteric liquid crystal layer is formed by applying a composition containing a disk-like liquid crystal compound onto the first cholesteric liquid crystal layer, forming a cholesteric liquid crystalline phase, and immobilizing an alignment state of the cholesteric liquid crystalline phase, a third cholesteric liquid crystal layer is formed on the second cholesteric liquid crystal layer in the same manner as the first cholesteric liquid crystal layer, and a fourth cholesteric liquid crystal layer is formed on the third cholesteric liquid crystal layer in the same manner as the second cholesteric liquid crystal layer.

The above-described first cholesteric liquid crystal layer and third cholesteric liquid crystal layer correspond to the reflective layer A of the first embodiment, and the above-described second cholesteric liquid crystal layer and fourth cholesteric liquid crystal layer correspond to the reflective layer B of the first embodiment.

In a case where the laminated reflective layer is formed in this manner, a light interference layer is formed on the surface of the laminated reflective layer.

The method of forming the light interference layer is not limited, and may be appropriately selected depending on the material for forming the light interference layer.

For example, in a case where the light interference layer is a positive C-plate formed of a liquid crystal compound, a composition including the liquid crystal compound configuring the positive C-plate may be prepared, the composition may be applied to the surface of the laminated reflective layer and dried, and the liquid crystal compound may be cured by ultraviolet irradiation or the like to form the light interference layer.

In addition, in a case where the light interference layer is a hardcoat layer, a composition containing a polymerizable compound serving as the hardcoat layer may be prepared, the composition may be applied to the surface of the laminated reflective layer and dried, and then the polymerizable compound may be cured by ultraviolet irradiation or the like to form the light interference layer.

Further, in a case where the light interference layer is a photo-alignment film, the light interference layer may be formed by preparing a composition containing a compound that forms a photo-alignment film, applying the composition to the surface of the laminated reflective layer, drying the composition, and curing the polymerizable compound by ultraviolet irradiation or the like.

In the present example, the light interference layer is formed on the laminated reflective layer, but conversely, the light interference layer may be formed first, and the reflective layer (cholesteric liquid crystal layer) may be formed on the light interference layer using the above-described composition.

Further, an adhesive layer is formed on the light interference layer to obtain the optical laminate according to the embodiment of the present invention.

The method of forming the adhesive layer is not limited, and various known methods depending on the material for forming the adhesive layer can be used. Therefore, the adhesive layer may be formed by a coating method or by bonding a sheet-shaped pressure sensitive adhesive layer.

In addition, in the optical laminate according to the embodiment of the present invention, the adhesive layer may be formed in a case of being bonded to an optical member (optical component) using the optical laminate according to the embodiment of the present invention.

For example, a composition serving as an adhesive layer may be applied to the optical member (optical component) using the optical laminate according to the embodiment of the present invention and/or the light interference layer of the laminate of the laminated reflective layer and the light interference layer produced as described above, and the optical member and the laminate of the laminated reflective layer and the light interference layer may adhere to each other with the adhesive layer to form an adhesive layer on the optical laminate according to the embodiment of the present invention. Alternatively, an adhesive layer consisting of a pressure sensitive adhesive or the like may be provided on the optical member (optical component) using the optical laminate according to the embodiment of the present invention, and the laminate of the laminated reflective layer and the light interference layer produced as described above may be laminated on the adhesive layer, the laminate facing the light interference layer side, and may be bonded to form an adhesive layer on the optical laminate according to the embodiment of the present invention.

In addition, in a case where the optical laminate according to the embodiment of the present invention is used for a reflective circular polarizer and the reflective circular polarizer is stretched or molded, the reflection wavelength range as the reflective circular polarizer may shift to the short wavelength side. Therefore, it is preferable that the optical laminate is manufactured in consideration of the shift of the wavelength in advance in the reflection wavelength range.

For example, in a case where an optical laminate including a layer formed by immobilizing the cholesteric liquid crystalline phase is used as the reflective circular polarizer, the optical laminate is stretched by being stretched and molded and thus a helical pitch of the cholesteric liquid crystalline phase may be reduced. Therefore, the helical pitch of the cholesteric liquid crystalline phase may be set to be large in advance. In addition, it is also preferable that the optical laminate includes an infrared light reflecting layer having a reflectivity of 40% or more at a wavelength of 800 nm in consideration of the shift of the reflection wavelength range to the short wavelength side due to the stretching and the molding.

Furthermore, in a case where a stretching ratio in the stretching and molding is not uniform in a plane, the optical laminate may be manufactured by selecting an appropriate reflection wavelength range according to the wavelength shift due to stretching at each location in the plane of the optical laminate. That is, the optical laminate may have regions with different reflection wavelength ranges in the plane. In addition, it is also preferable that the reflection wavelength range is set wider than the required wavelength range in advance in consideration that the stretching ratios at the respective locations in the plane of the optical laminate are different from each other.

In the above description, a method of directly applying a composition for forming a cholesteric liquid crystal layer to each cholesteric liquid crystal layer to form a cholesteric liquid crystal layer and a method of directly applying a composition for forming a light interference layer to a reflective layer consisting of a cholesteric liquid crystal layer to form a light interference layer have been described.

However, the method for manufacturing an optical laminate according to the embodiment of the present invention is not limited thereto, and the cholesteric liquid crystal layer and/or the light interference layer may be formed by applying each of the cholesteric liquid crystal layer and the light interference layer onto a different substrate. For example, the cholesteric liquid crystal layer and the light interference layer may be laminated with an adhesion layer (bonding layer) interposed therebetween, such as an adhesive layer or a pressure sensitive adhesive layer.

As the pressure sensitive adhesive used in the pressure sensitive adhesive layer, a commercially available pressure sensitive adhesive can be optionally used. Here, from the viewpoint of thinning and viewpoint of reducing the surface roughness Ra, the thickness of the pressure sensitive adhesive is preferably 25 μm or less, more preferably 15 μm or less, and still more preferably 6 μm or less. In addition, a pressure sensitive adhesive which is unlikely to generate outgas is preferable as the pressure sensitive adhesive. Particularly in a case where stretching and molding are performed, a vacuum process and a heating process may be performed, and it is preferable that no outgas is generated even under such conditions.

A commercially available adhesive or the like can be optionally used as the adhesive for the above-described adhesive layer, and for example, an epoxy resin-based adhesive and an acrylic resin-based adhesive can be used.

From the viewpoint of thinning and viewpoint of reducing a surface roughness Ra of the reflective circular polarizer as the optical laminate, a thickness of the adhesive is preferably 25 μm or less, more preferably 5 μm or less, and still more preferably 1 μm or less.

In addition, from the viewpoint of reducing the thickness of the adhesive layer and coating an adherend with the adhesive such that the thickness thereof is uniform, a viscosity of the adhesive is preferably 300 cP or less and more preferably 100 cP or less.

In addition, in a case where the adherend has surface unevenness, from the viewpoint of reducing the surface roughness Ra of the reflective circular polarizer as the optical laminate, appropriate viscoelasticity or an appropriate thickness of the pressure sensitive adhesive and the adhesive can also be selected so that the surface unevenness of the layer to be bonded can be embedded. From the viewpoint of embedding the surface unevenness, it is preferable that the pressure sensitive adhesive and the adhesive have a viscosity of 50 cP or greater. In addition, it is preferable that the thickness thereof is more than a height of the surface unevenness.

Examples of a method of adjusting the viscosity of the adhesive include a method of using an adhesive containing a solvent. In this case, the viscosity of the adhesive can be adjusted by a proportion of the solvent. In addition, the thickness of the adhesive can be further reduced by drying the solvent after coating the adherend with the adhesive.

In the optical laminate according to the embodiment of the present invention, from the viewpoint of reducing reflection at the interface and suppressing a decrease in polarization degree of transmitted light, it is preferable that the pressure sensitive adhesive or adhesive used for adhering each layer has a small difference in refractive index with adjacent layers.

Since the cholesteric liquid crystal layer has birefringence, refractive indices differ between a fast axis direction and a slow axis direction. In a case where an average refractive index nₐᵥₑ of a liquid crystal layer is obtained by adding the refractive indices in the fast axis direction and the slow axis direction and dividing by 2, a difference between a refractive index of the adjacent pressure sensitive adhesive layer or adhesive layer and nₐᵥₑ is preferably 0.075 or less, more preferably 0.05 or less, and still more preferably 0.025 or less. The refractive index of the pressure sensitive adhesive or the adhesive can be adjusted, for example, by mixing fine particles of titanium oxide, fine particles of zirconia, and the like.

In addition, in the adhesive layer between each layer, it is also preferable that the thickness is 100 nm or less. In a case where the thickness of the adhesive layer is 100 nm or less, light in the visible region is less likely to be affected by the difference in refractive index, and extra reflection can be suppressed. The thickness of the adhesive layer is more preferably 50 nm or less and still more preferably 30 nm or less.

Examples of a method of forming the adhesive layer having a thickness of 100 nm or less include a method of vapor-depositing a ceramic adhesive such as silicon oxide (SiOx layer) on the bonding surface. For the bonding surface of the bonding member, before the bonding, for example, a surface reforming treatment such as a plasma treatment, a corona treatment, and a saponification treatment can be performed, and a primer layer can be applied. In addition, in a case where a plurality of bonding surfaces are present, the kind and thickness of the adhesive layer can be adjusted for each of the bonding surfaces. Specifically, for example, the adhesive layer having a thickness of 100 nm or less can be provided by the procedures (1) to (3) described below.
(1) A layer to laminate is bonded to a temporary support consisting of a glass base material.
(2) A SiOx layer having a thickness of 100 nm or less is formed on both the surface of the layer to laminate and the surface of the layer to be laminated by vapor deposition or the like; the vapor deposition can be carried out by, for example, a vapor deposition device (model number ULEYES, manufactured by ULVAC, Inc.) using SiOx powder as a vapor deposition source; In addition, it is preferable that the surface of the formed SiOx layer is subjected to a plasma treatment.
(3) After the formed SiOx layers are bonded to each other, the temporary support is peeled off; it is preferable that the bonding is carried out, for example, at a temperature of 120° C.

The application, the adhesion, or the bonding of each layer may be carried out by a roll-to-roll or single-wafer method.

The roll-to-roll method is preferable from the viewpoint of improving the productivity and reducing axis misalignment of each layer.

Meanwhile, the single-wafer method is preferable from the viewpoints that this method is suitable for production of many kinds in small quantities and that a special adhesion method in which the thickness of the adhesive layer is 100 nm or less can be selected.

In addition, examples of the method of coating the adherend with the adhesive include known methods such as a roll coating method, a gravure printing method, a spin coating method, a wire bar coating method, an extrusion coating method, a direct gravure coating method, a reverse gravure coating method, a die coating method, a spraying method, and an ink jet method.

The reflective circular polarizer as the optical laminate according to the embodiment of the present invention may include a support, an alignment layer, or the like, but the support and the alignment layer may be a temporary support which is peeled off and removed during the production of a laminated optical film described later. It is preferable that a temporary support is used from the viewpoint that the thickness of the laminated optical film can be reduced by transferring the reflective circular polarizer to another laminate and peeling and removing the temporary support and the adverse effect of the retardation of the temporary support on the polarization degree of transmitted light can be eliminated.

The type of the support is not particularly limited, but it is preferable that the support is transparent to visible light. For example, films made of cellulose acylate, polycarbonate, polysulfone, polyethersulfone, polyacrylate and polymethacrylate, cyclic polyolefin, polyolefin, polyamide, polystyrene, polyester, or the like can be used. Among these, a cellulose acylate film, cyclic polyolefin, polyacrylate, or polymethacrylate is preferable. In addition, commercially available cellulose acetate films (for example, “TD80U” or “Z-TAC” manufactured by FUJIFILM Corporation) can also be used.

In a case where the support is a temporary support, a support having high tear strength is preferable from the viewpoint of preventing breakage during peeling. For example, a polycarbonate-based film and a polyester-based film are preferable.

In addition, from the viewpoint of suppressing the adverse effect on the polarization degree of transmitted light, it is preferable that the support has a small retardation. Specifically, a magnitude of Re at 550 nm is preferably 10 nm or less, and an absolute value of a magnitude of Rth is preferably 50 nm or less. In addition, even in a case where the support is used as the above-described temporary support, it is preferable that the temporary support has a small retardation from the viewpoint of performing quality inspection of the reflective circular polarizer and other laminates in a step of manufacturing a laminated optical film, which will be described later.

In addition, it is preferable that the reflective circular polarizer as the optical laminate, which is used in the laminated optical film described below, is transparent to near-infrared light in order to minimize the influence on various sensors incorporated in optical systems such as a virtual reality display device and an electronic finder, in which near-infrared light for eye tracking, facial expression recognition, and iris recognition is used as a light source.

[Laminated optical film]

The laminated optical film according to the embodiment of the present invention includes, in the following order, at least a reflective circular polarizer, a retardation layer which converts circularly polarized light into linearly polarized light, and a linear polarizer.

In the laminated optical film according to the embodiment of the present invention, the above-described optical laminate (first embodiment) according to the embodiment of the present invention is used as the reflective circular polarizer. Preferred aspects of the optical laminate (according to the first embodiment) are as described above.

As a suitable use example of the optical laminate according to the embodiment of the present invention and the laminated optical film including the optical laminate, a virtual reality display device using the laminated optical film according to the embodiment of the present invention is exemplified, and actions of the laminated optical film according to the embodiment of the present invention will be described in detail.

The virtual reality display device according to the embodiment of the present invention includes an optical article according to the embodiment of the present invention described below.

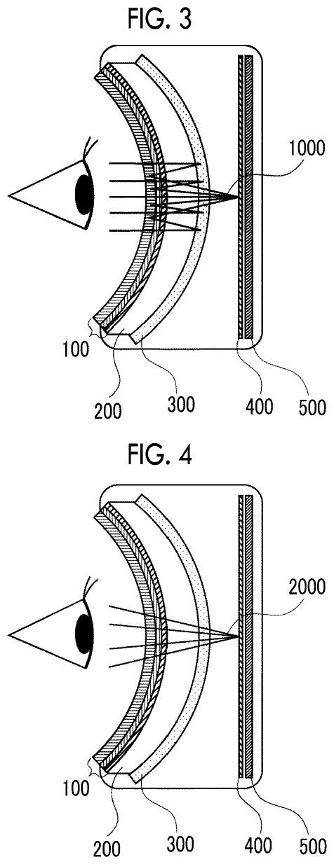

FIG. 3 is a schematic diagram of the virtual reality display device formed using the laminated optical film according to the embodiment of the present invention.

In the virtual reality display device of the aspect shown in FIG. 3, a laminated optical film 100 having the reflective circular polarizer as the above-described optical laminate, a lens 200, a half mirror 300, a circularly polarizing plate 400, and an image display panel 500 are arranged in this order from a visually recognizable side.

In addition, in the laminated optical film 100, a linear polarizer, a retardation layer, and a reflective circular polarizer are arranged in this order from the visually recognizable side. The laminated optical film 100 is bonded to the lens 200 by a reflective circular polarizer, that is, an adhesive layer provided in the optical laminate according to the embodiment of the present invention.

In the present example, as an example, the circularly polarizing plate 400 transmits light (image) emitted from the image display panel 500 as right circularly polarized light. In addition, the reflective layer of the laminated reflective layer constituting the reflective circular polarizer is a cholesteric liquid crystal layer that selectively reflects right circularly polarized light.

Further, in the laminated optical film 100, the slow axis and the transmission axis of the retardation layer and the linear polarizer are set such that the converted linearly polarized light is transmitted in a case where left circularly polarized light is incident from the retardation layer side.

As shown in FIG. 3, a ray 1000 (ray 1000 forming a virtual image) emitted from the image display panel 500 is transmitted through the circularly polarizing plate 400 to be circularly polarized light (right circularly polarized light) and is transmitted through the half mirror 300.

Next, the light is incident on the laminated optical film 100 according to the embodiment of the present invention from a side of the reflective circular polarizer, is totally reflected, is reflected by the half mirror 300 again, and is incident on the laminated optical film 100 again. Here, since the ray 1000 is reflected by the half mirror, the ray 1000 is converted into circularly polarized light (left circularly polarized light) having a turning direction opposite to that of the circularly polarized light in a case of incidence on the laminated optical film 100 for the first time. Therefore, the ray 1000 is transmitted through the laminated optical film 100 and visually recognized by a user.

In addition, in a case where the ray 1000 is reflected by the half mirror 300, since the half mirror has a concave mirror shape, an image displayed on the image display panel 500 by the half mirror 300 and the lens 200 is magnified so that the user can visually recognize the magnified virtual image. The system described above is referred to as a reciprocating optical system, a folded optical system, or the like.

On the other hand, FIG. 4 is a schematic diagram for explaining a case where the ghost occurs in the virtual reality display device shown in FIG. 3.

More specifically, FIG. 4 is a schematic diagram showing a case where a ray 2000 (ray 2000 forming a ghost) is transmitted without appropriately being reflected, so that the ray 2000 is leakage light, in a case where the ray 2000 is incident on the laminated optical film 100 for the first time in the virtual reality display device. As shown in FIG. 4, in a case where the ray 2000 is incident on the laminated optical film 100 for the first time, is transmitted without being reflected, and leakage light is generated, as can be seen from FIG. 4, the user visually recognizes an unenlarged image. This image is referred to as the ghost or the like, and the ghost or the like is required to be reduced.

Here, the reflective circular polarizer, that is, the optical laminate according to the embodiment of the present invention has a light interference layer between the adhesive layer and the laminated reflective layer as described above.

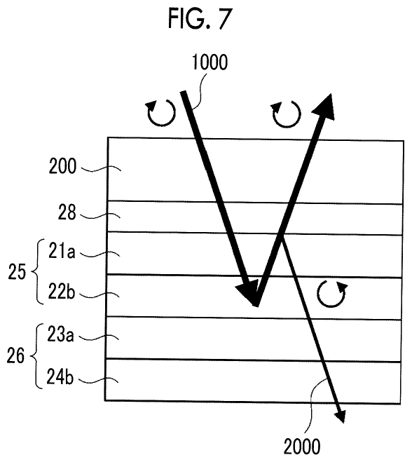

Therefore, it is possible to reduce this ghost. Hereinafter, the details will be described with reference to FIGS. 6 and 7. In FIGS. 6 and 7, the optical laminate 10 shown in FIG. 1 is shown as an example.

As conceptually shown in FIG. 7, the right circularly polarized light (ray 1000) emitted from the image display panel 500 and transmitted through the circularly polarizing plate 400 is incident from the lens 200 side, is transmitted through the adhesive layer 28, and is reflected toward the adhesive layer 28 by the reflective layers A 21a to B 24b.

In this case, a part of the right circularly polarized light (ray 1000) is reflected from the interface between the adhesive layer 28 and the reflective layer A 21a. In addition, in this case, the right circularly polarized light is converted into left circularly polarized light. Accordingly, the left circularly polarized light (ray 2000) transmits through the reflective layers A 21a to B 24b, the retardation layer, and the linear polarizer, that is, the laminated optical film 100, and is recognized as a ghost by the user.

On the other hand, as conceptually shown in FIG. 6, the optical laminate according to the embodiment of the present invention includes the light interference layer 27 between the adhesive layer 28 and the reflective layer A 21a (laminated reflective layer).

As described above, in the present invention, in a case where the refractive index of the adhesive layer 28 adjacent to the light interference layer 27 is nA and the average refractive index of the reflective layer (reflective layer A 21a) adjacent to the light interference layer is nL, the refractive index nI of the light interference layer 27 satisfies

$${( nA \times nL )}^{1 / 2} - 0.03 \leq nI \leq {( nA \times nL )}^{1 / 2} + 0.03 .$$

Therefore, in the optical laminate according to the embodiment of the present invention, the difference in refractive index at the interface of a layer present between the laminated reflective layer (reflective layer) and the adhesive layer can be reduced. In the example shown in the drawing, the difference in refractive index between the reflective layer (reflective layer A 21a) adjacent to the light interference layer of the laminated reflective layer and the light interference layer 27, and the difference in refractive index between the light interference layer 27 and the adhesive layer 28 can be reduced.

As a result, in the optical laminate according to the embodiment of the present invention, it is possible to reduce the interface reflection at the interface present between the adhesive layer 28 and the reflective layer A 21a, that is, the interface between the reflective layer A 21a and the light interference layer 27, and the interface between the light interference layer 27 and the adhesive layer 28. In FIG. 6, only the interface reflection between the light interference layer 27 and the adhesive layer 28 is shown in order to simplify the drawing.

The optical laminate according to the embodiment of the present invention has such a configuration, and thus can suppress a change in a turning direction of circularly polarized light generated by interface reflection, for example, a change from right circularly polarized light (ray 1000) to left circularly polarized light (ray 2000). As a result, for example, by using the optical laminate according to the embodiment of the present invention as reflected circularly polarizer of a virtual reality display device, ghosts can be reduced.

In addition, in the optical laminate according to the embodiment of the present invention, the film thickness of the light interference layer 27 is in a range of 60 to 110 nm or 230 to 330 nm.

As described above, in the optical laminate according to the embodiment of the present invention, since the difference in refractive index between the reflective layer A 21a adjacent to the light interference layer 27 and the light interference layer 27, and the difference in refractive index between the light interference layer 27 and the adhesive layer 28 are small, reflection at this interface can be reduced. However, even between the both interfaces, a small amount of interface reflection occurs.

On the other hand, in the optical laminate according to the embodiment of the present invention, the film thickness of the light interference layer 27, that is, the distance between the interfaces reflecting light is set to be in the above-described range.

In the present invention, with this configuration, a phase of light (ray 2000) reflected from an interface between the reflective layer A 21a and the light interference layer 27 and a phase of light (ray 2000) reflected from an interface between the light interference layer 27 and the adhesive layer 28 can be suitably shifted. In the present invention, with this configuration, it is preferable that the phase of light reflected from the interface between the reflective layer A 21a and the light interference layer 27 and the phase of light reflected from the interface between the light interference layer 27 and the adhesive layer 28 can be shifted by λ/2.

Therefore, in the optical laminate according to the embodiment of the present invention, reflected light at both interfaces can cancel out. As a result, with the optical laminate according to the embodiment of the present invention, it is possible to further reduce ghosts caused by unnecessary reflection of light at the interface.

In addition, the laminated optical film 100 according to the embodiment of the present invention, which has the laminated reflective layer including the reflective layer A and the reflective layer B, has a high polarization degree. Therefore, leakage of transmitted light (that is, the ghost) in a case where a ray is incident on the laminated optical film 100 for the first time can be reduced.

In addition, since the laminated optical film 100 according to the embodiment of the present invention has a high polarization degree with respect to the transmitted light, it is possible to increase the transmittance in a case where the ray is incidence on the laminated optical film 100 for the second time, and it is possible to improve brightness of the virtual image and further suppress tint of the virtual image.

As shown in FIGS. 3 and 4, the laminated optical film 100 may be molded on a curved surface of a lens or the like.

Since the optical film of the related art obtained by laminating a reflective linear polarizer and a retardation layer having a retardation of a ¼ wavelength, which is known as a reflective circular polarizer in the related art, has optical axes such as a transmission axis, a reflection axis, and a slow axis, the optical axes are distorted in a case of being stretched and molded into a curved shape, and thus the polarization degree of the transmitted light is decreased. On the contrary, in the laminated optical film 100 according to the embodiment of the present invention, since the reflective circular polarizer (optical laminate) has no optical axis, a decrease in polarization degree due to stretching and molding is unlikely to occur. Therefore, even in a case where the laminated optical film 100 is molded into a curved surface shape, the decrease in polarization degree is unlikely to occur.

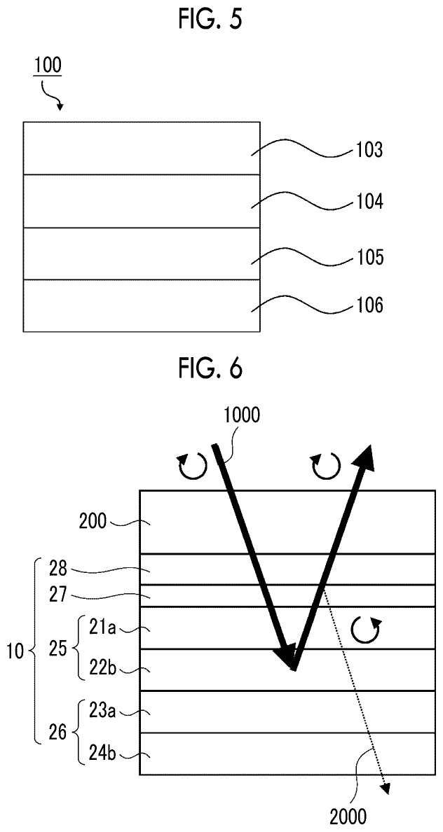

FIG. 5 shows an example of a layer configuration of the laminated optical film 100 according to the embodiment of the present invention.

In the laminated optical film 100 shown in FIG. 5, a reflective circular polarizer 103, a positive C-plate 104, a retardation layer 105, and a linear polarizer 106 are arranged in this order. As described above, the reflective circular polarizer 103 uses the optical laminate according to the embodiment of the present invention. The laminated optical film 100 shown in FIG. 5 includes the positive C-plate 104 as a preferred aspect, but the laminated optical film according to the embodiment of the present invention may not include the positive C-plate 104.

Since the laminated optical film according to the embodiment of the present invention includes the reflective circular polarizer 103, the retardation layer 105 which converts circularly polarized light into linearly polarized light, and the linear polarizer 106 in this order, leakage light from the reflective circular polarizer 103 is converted into the linearly polarized light, and the light can be absorbed by the linear polarizer. Therefore, the polarization degree of the transmitted light can be increased.

In a case where the laminated optical film is stretched or molded, the slow axis of the retardation layer, the absorption axis of the linear polarizer, and the like may be distorted. However, as described above, the reflective circular polarizer maintains a high polarization degree even after being stretched and molded, and the amount of leakage light from the reflective circular polarizer is small, the increase in leakage light is suppressed to a slight amount.

In addition, it is preferable that a surface roughness Ra of the laminated optical film according to the embodiment of the present invention is 100 nm or less. In a case where the Ra is small, sharpness of the image can be improved, for example, in a case where the laminated optical film is used in the virtual reality display device or the like. The present inventors have presumed that, in a case where the light is reflected on the laminated optical film, an angle of the reflected light is distorted in a case where the laminated optical film has unevenness, which leads to image distortion and blurriness. The Ra of the laminated optical film is more preferably 50 nm or less, still more preferably 30 nm or less, and particularly preferably 10 nm or less.

In addition, the laminated optical film according to the embodiment of the present invention is produced by laminating a plurality of layers. According to the studies conducted by the present inventors, it has been found that, in a case where a layer is laminated on a layer with unevenness, the unevenness may be amplified. Therefore, in the laminated optical film according to the embodiment of the present invention, it is preferable that all the layers have a small Ra. Each layer of the laminated optical film according to the embodiment of the present invention has Ra of preferably 50 nm or less, more preferably 30 nm or less, and still more preferably 10 nm or less.

In addition, from the viewpoint of increasing the image sharpness of the reflected image, it is particularly preferable that the reflective circular polarizer has a small surface roughness Ra.

The surface roughness Ra can be measured by, for example, a non-contact surface/layer cross-sectional shape measuring system VertScan (manufactured by Ryoka System, Inc.).

Since the Vertscan is a surface shape measurement method using a phase of reflected light from a sample, in a case of measuring a reflective circular polarizer consisting of a reflective layer obtained by immobilizing a cholesteric liquid crystalline phase (the above-described optical laminate), the reflected light from inside the film may overlap, and thus the surface shape may not be accurately measured. In this case, a metal layer may be formed on the surface of the sample to increase the reflectivity of the surface and further suppress the reflection from the inside. As a method of forming the metal layer on the surface of the sample, for example, a sputtering method is used. Au, Al, Pt, or the like is used as a material to be sputtered.

It is preferable that the number of point defects per unit area in the laminated optical film according to the embodiment of the present invention is small. Since the laminated optical film according to the embodiment of the present invention is produced by laminating a large number of layers, it is preferable that the number of point defects in each layer is also small in order to reduce the number of point defects in the entire laminated optical film. Specifically, the number of point defects in each layer is preferably 20 or less, more preferably 10 or less, and still more preferably 1 or less per square meter. The number of point defects in the entire laminated optical film is preferably 100 or less, more preferably 50 or less, and still more preferably 5 or less per square meter.

Since the point defects lead to a decrease in polarization degree of transmitted light or a decrease in image sharpness, it is preferable that the number of point defects is small.

Here, the point defects include foreign matter, scratches, stains, fluctuations in film thickness, alignment failure of a liquid crystal compound, and the like.

In addition, it is preferable that the number of the above-described point defects is counted with the number of point defects having a size of preferably 100 μm or more, more preferably 30 μm or more, and still more preferably 10 μm or more.

In addition, various sensors may be incorporated in optical systems such as a virtual reality display device and an electronic finder, in which near-infrared light for eye tracking, facial expression recognition, and iris recognition is used as a light source, and in order to minimize the influence on the sensor, it is preferable that the laminated optical film according to the embodiment of the present invention is transparent to near-infrared light.

[Retardation layer]

The retardation layer used in the laminated optical film according to the embodiment of the present invention has a function of converting emitted light into substantially linearly polarized light in a case where circularly polarized light is incident. For example, a retardation layer in which the Re is an approximately ¼ wavelength at any of the wavelengths in the visible region can be used. Here, an in-plane retardation Re(550) at a wavelength of 550 nm is preferably 120 to 150 nm, more preferably 125 to 145 nm, and still more preferably 135 to 140 nm.

Further, a retardation layer in which the Re is an approximately ¾ wavelength and the Re is an approximately 5/4 wavelength is also preferable from the viewpoint that circularly polarized light can be converted into linearly polarized light.

In addition, it is preferable that the retardation layer used in the laminated optical film according to the embodiment of the present invention has reverse dispersibility with respect to the wavelength. It is preferable that the retardation layer has reverse dispersibility from the viewpoint that circularly polarized light can be converted into linearly polarized light over a wide wavelength range in the visible region. Here, the expression “having reverse dispersibility with respect to the wavelength” denotes that as the wavelength increases, the value of the retardation at the wavelength increases.

The retardation layer having reverse dispersibility can be prepared, for example, by uniaxially stretching a polymer film such as a modified polycarbonate resin film having reverse dispersibility with reference to JP2017-049574A and the like.

In addition, the retardation layer having reverse dispersibility is not limited as long as the retardation layer substantially has reverse dispersibility, and can be prepared by laminating a retardation layer having Re of an approximately ¼ wavelength and a retardation layer having Re of an approximately ½ wavelength such that the slow axes form an angle of approximately 600 as described in, for example, JP06259925B. Here, it is known that even in a case where the ¼ wavelength retardation layer and the ½ wavelength retardation layer each have forward dispersibility (as the wavelength increases, the value of the retardation at the wavelength decreases), circularly polarized light can be converted into linearly polarized light over a wide wavelength range in the visible region, and the layers can be regarded as having substantially reverse dispersibility. In this case, it is preferable that the laminated optical film according to the embodiment of the present invention includes a reflective circular polarizer, a ¼ wavelength retardation layer, a ½ wavelength retardation layer, and a linear polarizer in this order.

In addition, it is also preferable that the retardation layer used in the laminated optical film according to the embodiment of the present invention has a layer formed by immobilizing uniformly aligned liquid crystal compounds. For example, a layer formed by uniformly aligning rod-like liquid crystal compounds horizontally to the in-plane direction and a layer formed by uniformly aligning disk-like liquid crystal compounds vertically to the in-plane direction can be used.

Furthermore, for example, a retardation layer having reverse dispersibility can be prepared by uniformly aligning rod-like liquid crystal compounds having reverse dispersibility and immobilizing the compounds with reference to JP2020-084070A and the like.

In addition, it is also preferable that the retardation layer used in the laminated optical film according to the embodiment of the present invention has a layer formed by immobilizing twistedly aligned liquid crystal compounds with a helical axis in the thickness direction.

For example, as described in JP05753922B and JP05960743B, a retardation layer having a layer formed by immobilizing twistedly aligned rod-like liquid crystal compounds or twistedly aligned disk-like liquid crystal compounds with a helical axis in the thickness direction can also be used. In this case, the retardation layer can be regarded as having substantially reverse dispersibility, which is preferable.

A thickness of the retardation layer is not particularly limited, but from the viewpoint of thinning, it is preferably 0.1 to 8 μm and more preferably 0.3 to 5 μm.

In the laminated optical film according to the embodiment of the present invention, the retardation layer may include a support, an alignment layer, and the like.

In addition, the support and the alignment layer may be temporary supports that are peeled off and removed during the preparation of the laminated optical film. It is preferable that a temporary support is used from the viewpoint that the thickness of the laminated optical film can be reduced by transferring the retardation layer to another laminate and peeling and removing the temporary support and the adverse effect of the retardation of the temporary support on the polarization degree of transmitted light can be eliminated.

The type of the support is not particularly limited, but it is preferable that the support is transparent to visible light, and examples thereof include films made of cellulose acylate, polycarbonate, polysulfone, polyethersulfone, polyacrylate and polymethacrylate, cyclic polyolefin, polyolefin, polyamide, polystyrene, polyester, or the like. Among these, a cellulose acylate film, cyclic polyolefin, polyacrylate, or polymethacrylate is preferable. In addition, as the support, a commercially available cellulose acetate film can also be used. Examples of the commercially available cellulose acetate film include “TD80U” and “Z-TAC” manufactured by FUJIFILM Corporation.

In a case where the support is a temporary support, a support having high tear strength is preferable from the viewpoint of preventing breakage during peeling. For example, a polycarbonate-based film and a polyester-based film are preferable.

In addition, from the viewpoint of suppressing the adverse effect on the polarization degree of transmitted light, it is preferable that the support has a small retardation. Specifically, a magnitude of Re(550) is preferably 10 nm or less, and an absolute value of a magnitude of Rth is preferably 50 nm or less. Further, even in a case where the support is used as the temporary support described above, it is preferable that the temporary support has a small retardation from the viewpoint of performing quality inspection of the retardation layer and other laminates in the step of producing a laminated optical film.

In addition, it is preferable that the retardation layer used in the laminated optical film according to the embodiment of the present invention is transparent to near-infrared light in order to minimize the influence on various sensors incorporated in optical systems such as a virtual reality display device, an electronic finder, and the like, in which near-infrared light for eye tracking, facial expression recognition, and iris recognition is used as a light source.

[Linear polarizer]

The linear polarizer used in the laminated optical film according to the embodiment of the present invention is preferably an absorption type linear polarizer. The absorption type linear polarizer absorbs linearly polarized light in an absorption axis direction among incidence rays, and transmits linearly polarized light in a transmission axis direction.

A typical polarizer can be used as the linear polarizer, and examples thereof may include a polarizer in which a dichroic substance is dyed on polyvinyl alcohol and another polymer resin and is stretched so that the dichroic substance is aligned and a polarizer in which a dichroic substance is aligned by using alignment of a liquid crystal compound. Among these, from the viewpoints of the availability and an increase in the polarization degree, a polarizer obtained by dyeing polyvinyl alcohol with iodine and stretching polyvinyl alcohol is preferable.

A thickness of the linear polarizer is preferably 10 μm or less, more preferably 7 m or less, and still more preferably 5 μm or less. In a case where the linear polarizer is thin, cracks, breakage, and the like can be prevented in a case where the laminated optical film is stretched or molded.

In addition, a single plate transmittance of the linear polarizer is preferably 40% or more and more preferably 42% or more. Moreover, the polarization degree is preferably 90% or more, more preferably 95% or more, and still more preferably 99% or more. In the present specification, the single plate transmittance and the polarization degree of the linear polarizer are measured using an automatic polarizing film measuring device: VAP-7070 (manufactured by Jasco Corporation).

In addition, it is preferable that the direction of the transmission axis of the linear polarizer coincides with the direction of the polarization axis of light converted into linearly polarized light by the retardation layer. For example, in a case where the retardation layer is a layer having a retardation of a ¼ wavelength, an angle between the transmission axis of the linear polarizer and the slow axis of the retardation layer is preferably approximately 45°.

It is also preferable that the linear polarizer used in the laminated optical film according to the embodiment of the present invention is a light absorption anisotropic layer containing a liquid crystal compound and a dichroic substance. A linear polarizer containing a liquid crystal compound and a dichroic substance is preferable from the viewpoint that the thickness thereof can be reduced and cracks, breakage, and the like are unlikely to occur even in a case where the laminated optical film is stretched, molded, or the like. A thickness of the light absorption anisotropic layer is not particularly limited, but from the viewpoint of thinning, it is preferably 0.1 to 8 μm and more preferably 0.3 to 5 μm.

The linear polarizer containing a liquid crystal compound and a dichroic substance can be produced with reference to, for example, JP2020-023153A. From the viewpoint of improving the polarization degree of the linear polarizer, an alignment degree of the dichroic substance in the light absorption anisotropic layer is preferably 0.95 or more and more preferably 0.97 or more.

A liquid crystal compound which does not exhibit dichroic properties in the visible region is preferable as a liquid crystal compound contained in a composition used for forming the light absorption anisotropic layer, which is used to form the light absorption anisotropic layer.

As such a liquid crystal compound, both a low-molecular-weight liquid crystal compound and a polymer liquid crystal compound can be used. Here, the “low-molecular-weight liquid crystal compound” denotes a liquid crystal compound having no repeating units in the chemical structure. In addition, the “polymer liquid crystal compound” refers to a liquid crystal compound including a repeating unit in a chemical structure.

Examples of the polymer liquid crystal compound include thermotropic liquid crystal polymers described in JP2011-237513A. In addition, the polymer liquid crystal compound preferably has a crosslinkable group at a terminal. Examples of the crosslinkable group contained in the terminal of the polymer liquid crystal compound include an acryloyl group and a methacryloyl group.

The liquid crystal compound may be used alone or in combination of two or more kinds thereof. It is also preferable that the polymer liquid crystal compound and the low-molecular-weight liquid crystal compound are used in combination.

A content of the liquid crystal compound is preferably 25 to 2000 parts by mass, more preferably 33 to 1000 parts by mass, and still more preferably 50 to 500 parts by mass with respect to 100 parts by mass of a content of the dichroic substance in the present composition. In a case where the content of the liquid crystal compound is within the above-described range, the alignment degree of the polarizer is further improved.

The dichroic substance contained in the composition for forming the light absorption anisotropic layer, which is used to form the light absorption anisotropic layer, is not particularly limited, and examples thereof include a visible light absorbing substance (dichroic coloring agent), an ultraviolet absorbing substance, an infrared absorbing substance, a nonlinear optical substance, and a carbon nanotube. In addition, known dichroic substances (dichroic coloring agents) of the related art can be used.

In the present invention, two or more kinds of dichroic substances may be used in combination. For example, from the viewpoint of obtaining a high polarization degree over a wider wavelength range, it is preferable that at least one dichroic substance having a maximal absorption wavelength in a wavelength range of 370 to 550 nm and at least one dichroic substance having a maximal absorption wavelength in a wavelength range of 500 to 700 nm are used in combination.

In a case where the linear polarizer according to the embodiment of the present invention includes the light absorption anisotropic layer containing the liquid crystal compound and the dichroic substance, the linear polarizer may include a support, an alignment layer, or the like, but the support and the alignment layer may be a temporary support which is peeled off during the production of the laminated optical film.

It is preferable that a temporary support is used from the viewpoint that the thickness of the laminated optical film can be reduced by transferring the light absorption anisotropic layer to another laminate and peeling and removing the temporary support and the adverse effect of the retardation of the temporary support on the polarization degree of transmitted light can be eliminated.

The type of the support is not particularly limited, but it is preferable that the support is transparent to visible light, and for example, the same support as the support used in the above-described retardation layer can be used. Preferred aspects of the support used in the linear polarizer are the same as the preferred aspects of the support used in the above-described retardation layer.

In addition, it is preferable that the linear polarizer used in the laminated optical film according to the embodiment of the present invention is transparent to near-infrared light in order to minimize the influence on various sensors incorporated in optical systems such as a virtual reality display device, an electronic finder, and the like, in which near-infrared light for eye tracking, facial expression recognition, and iris recognition is used as a light source.

[Other functional layers]

The laminated optical film according to the embodiment of the present invention may have other functional layers in addition to the reflective circular polarizer, the retardation layer, and the linear polarizer.

In addition, it is preferable that the other functional layers are transparent to near-infrared light in order to minimize the influence on various sensors incorporated in optical systems such as a virtual reality display device and an electronic finder, in which near-infrared light for eye tracking, facial expression recognition, and iris recognition is used as a light source.

### <Positive C-Plate>

As shown in FIG. 5, it is also preferable that the laminated optical film according to the embodiment of the present invention further includes a positive C-plate. Here, the positive C-plate is a retardation layer in which the Re is substantially zero and the Rth has a negative value.

The positive C-plate can be obtained, for example, by vertically aligning rod-like liquid crystal compounds. With regard to the details of the method for manufacturing the positive C-plate, reference can be made to the description in, for example, JP2017-187732A, JP2016-053709A, JP2015-200861A, and the like.

The positive C-plate functions as an optical compensation layer for increasing the polarization degree of the transmitted light with respect to light incident obliquely. The positive C-plates can be provided at any position of the laminated optical film, and a plurality of the positive C-plates may be provided.

The positive C-plate may be installed adjacent to the reflective circular polarizer or inside the reflective circular polarizer.

For example, in a case where a reflecting layer containing a rod-like liquid crystal compound, which is formed by immobilizing a cholesteric liquid crystalline phase, is used as the reflective circular polarizer, the reflective layer has a positive Rth. Here, in a case where light is incident on the reflective circular polarizer in an oblique direction, the polarization states of the reflected light and the transmitted light may change due to the action of the Rth, and the polarization degree of the transmitted light may decrease. In a case where the positive C-plate is provided inside or in the vicinity of the reflective circular polarizer, the change in polarization state of the oblique incident light can be further suppressed, so that the decrease in polarization degree of the transmitted light can be further suppressed, and as a result, the ghost can be further suppressed, which is preferable.

According to the studies by the present inventors, it is preferable that the positive C-plate is installed on a surface of the blue light reflecting layer on a side opposite to the green light reflecting layer, but the positive C-plate may be installed at another place. Re(550) of the positive C-plate in this case is preferably approximately 10 nm or less, and Rth(550) thereof is preferably −600 to −100 nm and more preferably −400 to −200 nm.

In addition, the positive C-plate may be provided adjacent to the retardation layer or inside the retardation layer. For example, in a case where a layer formed by immobilizing a rod-like liquid crystal compound is used as the retardation layer, the retardation layer has a positive Rth. Here, in a case where light is incident on the retardation layer in an oblique direction, the polarization state of the transmitted light may change due to the action of the Rth, and the polarization degree of the transmitted light may decrease. In a case where the positive C-plate is provided inside the retardation layer or in the vicinity thereof, the change in polarization state of the oblique incident light is suppressed and the decrease in polarization degree of the transmitted light can be suppressed, which is preferable. According to the studies by the present inventors, it is preferable that the positive C-plate is installed on a surface of the retardation layer on a side opposite to the linear polarizer, but the positive C-plate may be installed at another place. In this case, Re(550) of the positive C-plate is preferably approximately 10 nm or less, and Rth(550) is preferably −90 to −40 nm.

<Antireflection layer>

It is also preferable that the laminated optical film according to the embodiment of the present invention includes an antireflection layer on a surface thereof. The laminated optical film according to the embodiment of the present invention has a function of reflecting specific circularly polarized light and transmitting circularly polarized light orthogonal to the specific circularly polarized light, and the reflection on a surface of the laminated optical film typically includes unintended reflection of polarized light, which may lead to the decrease in polarization degree of the transmitted light. Therefore, it is preferable that the laminated optical film includes an antireflection layer on the surface thereof. The antireflection layer may be provided only on one surface or on both surfaces of the laminated optical film.

The type of the antireflection layer is not particularly limited, but from the viewpoint of further decreasing the reflectivity, a moth-eye film and an anti-reflective (AR) film are preferable. As the moth-eye film and the AR film, known films can be used.

In addition, in a case where the laminated optical film is stretched or molded, the moth-eye film is preferable from the viewpoint that high antireflection performance can be maintained even in a case of fluctuation in the film thickness due to the stretching. Furthermore, in a case where the antireflection layer includes a support and stretching and molding are performed, from the viewpoint of facilitating the stretching and the molding, a peak temperature of the glass transition temperature Tg of the above-described support is preferably 170° C. or lower and more preferably 130° C. or lower. Specifically, the support is preferably, for example, a PMMA film or the like.

### <Second Retardation Layer>

It is also preferable that the laminated optical film according to the embodiment of the present invention further includes a second retardation layer. For example, the laminated optical film according to the embodiment of the present invention may include the reflective circular polarizer, the retardation layer, the linear polarizer, and the second retardation layer in this order.

It is preferable that the second retardation layer converts linearly polarized light into circularly polarized light, and for example, a retardation layer having Re of a ¼ wavelength is preferable. The reason for this will be described below.

Light which has been incident on the laminated optical film from the side of the reflective circular polarizer and transmitted through the reflective circular polarizer, the retardation layer, and the linear polarizer is converted into linearly polarized light, and a part of the light is reflected on the outermost surface on the side of the linear polarizer and emitted from the surface on the side of the reflective circular polarizer again. Such light is extra reflected light and may decrease the polarization degree of the reflected light, and thus it is preferable that the amount of such light is reduced. Therefore, a method of laminating an antireflection layer may be considered to suppress reflection on the outermost surface on the side of the linear polarizer, but in a case where the laminated optical film is used by being bonded to a medium such as glass or plastic, the antireflection effect is hardly obtained because reflection on the surface of the medium cannot be suppressed even in a case where the antireflection layer is provided on the bonding surface of the laminated optical film.

Meanwhile, in a case where the second retardation layer which converts linearly polarized light into circularly polarized light is provided, light which reaches the outermost surface on the side of the linear polarizer is converted into circularly polarized light, and converted into circularly polarized light orthogonal to each other in a case of reflection on the outermost surface of the medium. Thereafter, in a case where the light is transmitted through the second retardation layer again and reaches the linear polarizer, the light is converted into linearly polarized light in the absorption axis azimuth of the linear polarizer and absorbed by the linear polarizer. Therefore, it is possible to prevent extra reflection.

From the viewpoint of more effectively suppressing the extra reflection, it is preferable that the second retardation layer has substantially reverse dispersibility.

### <Support>

The laminated optical film according to the embodiment of the present invention may further include a support (resin base material). The support can be provided at any position, and for example, in a case where the reflective circular polarizer, the retardation layer, or the linear polarizer is a film used by being transferred from the temporary support, the support can be used as a transfer destination thereof.

The type of the support is not particularly limited, but it is preferable that the support is transparent to visible light, and examples thereof include films made of cellulose acylate, polycarbonate, polysulfone, polyethersulfone, polyacrylate and polymethacrylate, cyclic polyolefin, polyolefin, polyamide, polystyrene, polyester, or the like. Among these, a cellulose acylate film, a cyclic polyolefin, a polyacrylate, and a polymethacrylate are preferable examples. In addition, a commercially available cellulose acetate film can also be used as the support. Examples of the commercially available cellulose acetate film include “TD80U” and “Z-TAC” manufactured by FUJIFILM Corporation.

In addition, it is preferable that the support has a small retardation from the viewpoint of suppressing the adverse effect on the polarization degree of the transmitted light and viewpoint of facilitating the optical inspection of the laminated optical film. Specifically, a magnitude of Re(550) is preferably 10 nm or less, and an absolute value of a magnitude of Rth(550) is preferably 50 nm or less.

In a case where the laminated optical film according to the embodiment of the present invention is stretched and molded, the support (resin base material) preferably has a peak temperature of a loss tangent tan δ of 170° C. or lower. From the viewpoint that the laminated optical film can be molded at a low temperature, the peak temperature of the loss tangent tan δ is preferably 150° C. or lower and more preferably 130° C. or lower.

Here, a method of measuring a loss tangent tan δ will be described.
E″ (loss elastic modulus) and E′ (storage elastic modulus) of a film sample which has been humidity-adjusted in advance in an atmosphere of a temperature of 25° C. and a relative humidity of 60% RH for 2 hours or longer are measured under the following conditions using a dynamic viscoelasticity measuring device (DVA-200, manufactured by IT Measurement & Control Co., Ltd.), and the values are used to acquire a loss tangent tan δ (=E″/E′).
Device: DVA-200, manufactured by IT Measurement & Control Co., Ltd.
Sample: 5 mm, length of 50 mm (gap of 20 mm)
Measurement conditions: tension mode
Measurement temperature: −150° C. to 220° C.
Heating conditions: 5° C./min
Frequency: 1 Hz
Typically in optical applications, a resin base material subjected to a stretching treatment is frequently used, and the peak temperature of the loss tangent tan δ is frequently increased due to the stretching treatment. For example, with a triacetyl cellulose (TAC) base material (TG40 manufactured by FUJIFILM Corporation), the peak temperature of tan δ is 180° C. or higher.

The support having a peak temperature of the loss tangent tan δ of 170° C. or lower is not particularly limited, and various resin base materials can be used. Examples thereof include polyolefin such as polyethylene, polypropylene, and a norbornene-based polymer; a cyclic olefin-based resin; polyvinyl alcohol; polyethylene terephthalate; an acrylic resin such as polymethacrylic acid ester and polyacrylic acid ester; polyethylene naphthalate; polycarbonate; polysulfone; polyethersulfone; polyetherketone; polyphenylene sulfide, and polyphenylene oxide. Among these, from the viewpoint of being easily available from the market and having excellent transparency, a cyclic olefin-based resin, polyethylene terephthalate, and an acrylic resin are preferable, and a cyclic olefin-based resin and polymethacrylic acid ester are particularly preferable.

Examples of commercially available resin base materials include TECHNOLLOY S001G, TECHNOLLOY S014G, TECHNOLLOY S000, TECHNOLLOY C001, and TECHNOLLOY C000 (manufactured by Sumika Acryl Co., Ltd.), LUMIRROR U type, LUMIRROR FX10, and LUMIRROR SF20 (Toray Industries, Inc.), HK-53A (Higashiyama Film Co., Ltd.), TEFLEX FT3 (TOYOBO CO., LTD.), ESCENA and SCA40 (Sekisui Chemical Co., Ltd.), a ZEONOR Film (ZEON CORPORATION), and an Arton Film (JSR Corporation).

A thickness of the support is not particularly limited, and is preferably 5 to 300 μm, more preferably 5 to 100 μm, and still more preferably 5 to 30 μm.

In addition, the laminated optical film may include a layer other than the above-described layers. Examples of the layer other than the above-described layers include a pressure sensitive adhesive layer formed from a pressure sensitive adhesive described later, an adhesive layer formed from an adhesive described later, and a refractive index adjusting layer.

In addition, a refractive index adjusting layer in which a difference in refractive index between a fast axis direction and a slow axis direction is smaller than that of the reflective circular polarizer may be provided between the reflective circular polarizer and the pressure sensitive adhesive or between the reflective circular polarizer or the adhesive. In this case, the refractive index adjusting layer preferably has a layer obtained by fixing an alignment state of cholesteric liquid crystals. By providing the refractive index adjusting layer, interface reflection can be further suppressed, and occurrence of the ghost can be further suppressed. In addition, it is more preferable that an average refractive index of the refractive index adjusting layer is smaller than the average refractive index of the reflective circular polarizer. In addition, a central wavelength of reflected light of the refractive index adjusting layer may be less than 430 nm or more than 670 nm, and is more preferably less than 430 nm.

[Method of bonding each layer]

The laminated optical film according to the embodiment of the present invention is a laminate consisting of a plurality of layers. Each layer can be bonded (attached) by an optional adhesion method, and for example, a pressure sensitive adhesive and an adhesive can be used.

Any commercially available pressure sensitive adhesive can be used as the pressure sensitive adhesive, but from the viewpoint of thinning and viewpoint of reducing a surface roughness Ra of the laminated optical film, a thickness thereof is preferably 25 μm or less, more preferably 15 μm or less, and still more preferably 6 μm or less. In addition, a pressure sensitive adhesive which is unlikely to generate outgas is preferable as the pressure sensitive adhesive. Particularly in a case where the laminated optical film is stretched and molded, a vacuum process, a heating process, or the like may be performed, and it is preferable that no outgas is generated even under such conditions.

A commercially available adhesive or the like can be optionally used as the adhesive, and for example, an epoxy resin-based adhesive, an acrylic resin-based adhesive, or the like can be used.

From the viewpoint of thinning and viewpoint of reducing the surface roughness Ra of the laminated optical film, a thickness of the adhesive is preferably 25 μm or less, more preferably 5 μm or less, and still more preferably 1 μm or less. In addition, from the viewpoint of reducing the thickness of the adhesive layer and coating an adherend with the adhesive such that the thickness thereof is uniform, a viscosity of the adhesive is preferably 300 cP or less, more preferably 100 cP or less, and still more preferably 10 cP or less.

In addition, in a case where the adherend has surface unevenness, from the viewpoint of reducing the surface roughness Ra of the laminated optical film, appropriate viscoelasticity or an appropriate thickness of the pressure sensitive adhesive and the adhesive can also be selected so that the surface unevenness of the layer to be bonded can be embedded. From the viewpoint of embedding the surface unevenness, it is preferable that the pressure sensitive adhesive and the adhesive have a viscosity of 50 cP or greater. In addition, it is preferable that the thickness thereof is more than a height of the surface unevenness.

Examples of a method of adjusting the viscosity of the adhesive include a method of using an adhesive containing a solvent. In this case, the viscosity of the adhesive can be adjusted by a proportion of the solvent. In addition, the thickness of the adhesive can be further reduced by drying the solvent after coating the adherend with the adhesive.

In the laminated optical film, from the viewpoint of reducing the extra reflection and suppressing a decrease in polarization degrees of transmitted light and reflected light, it is preferable that the pressure sensitive adhesive or adhesive used for adhering each layer has a small difference in refractive index with adjacent layers. Specifically, the difference in refractive index with the adjacent layer is preferably 0.1 or less, more preferably 0.05 or less, and still more preferably 0.01 or less. The refractive index of the pressure sensitive adhesive or the adhesive can be adjusted, for example, by mixing fine particles of titanium oxide, fine particles of zirconia, and the like.

In addition, the reflective circular polarizer, the retardation layer, and the linear polarizer may have in-plane refractive index anisotropy, but the difference in refractive index with the adjacent layer is preferably 0.05 or less in all in-plane directions. Therefore, the pressure sensitive adhesive and the adhesive may have in-plane refractive index anisotropy.

In addition, in the adhesive layer between each layer, it is also preferable that a thickness of the adhesive layer is 100 nm or less. In a case where the thickness of the adhesive layer is 100 nm or less, light in the visible region is less likely to be affected by the difference in refractive index, and the reflection at the interface can be suppressed. The thickness of the adhesive layer is more preferably 50 nm or less. Examples of a method of forming the adhesive layer having a thickness of 100 nm or less include a method of vapor-depositing a ceramic adhesive such as silicon oxide (SiOx layer) on the bonding surface. For the bonding surface of the bonding member, before the bonding, a surface reforming treatment such as a plasma treatment, a corona treatment, and a saponification treatment can be performed, and a primer layer can be applied. In addition, in a case where a plurality of bonding surfaces are present, the kind, thickness, and the like of the adhesive layer can be adjusted for each of the bonding surfaces. Specifically, for example, the adhesive layer having a thickness of 100 nm or less can be provided by the procedures (1) to (3) described below.
(1) A layer to laminate is bonded to a temporary support consisting of a glass base material.
(2) A SiOx layer having a thickness of 100 nm or less is formed on both the surface of the layer to laminate and the surface of the layer to be laminated by vapor deposition or the like; the vapor deposition can be carried out by, for example, a vapor deposition device (model number ULEYES, manufactured by ULVAC, Inc.) using SiOx powder as a vapor deposition source; In addition, it is preferable that the surface of the formed SiOx layer is subjected to a plasma treatment.
(3) After the formed SiOx layers are bonded to each other, the temporary support is peeled off; it is preferable that the bonding is carried out, for example, at a temperature of 120° C.

The application, the adhesion, or the bonding of each layer may be carried out by roll-to-roll or single-wafer. The roll-to-roll method is preferable from the viewpoint of improving the productivity and reducing axis misalignment of each layer.

Meanwhile, the single-wafer method is preferable from the viewpoints that this method is suitable for production of many kinds in small quantities and that a special adhesion method in which the thickness of the adhesive layer is 100 nm or less can be selected. In addition, examples of the method of coating the adherend with the adhesive include known methods such as a roll coating method, a gravure printing method, a spin coating method, a wire bar coating method, an extrusion coating method, a direct gravure coating method, a reverse gravure coating method, a die coating method, a spraying method, and an ink jet method.

[Direct application of each layer]

It is also preferable that no adhesive layer is provided between each layer of the laminated optical film according to the embodiment of the present invention. In a case of forming a layer, the adhesive layer can be eliminated by directly coating an adjacent layer which has already been formed.

Furthermore, in a case where one or both adjacent layers are layers containing a liquid crystal compound, it is preferable that the alignment direction of the liquid crystal compound is continuously changed at the interface in order to reduce the difference in refractive index in all in-plane directions. For example, the linear polarizer containing a liquid crystal compound and a dichroic substance is directly coated with a retardation layer containing a liquid crystal compound, and the liquid crystal compound of the retardation layer can be aligned to be continuous at the interface by alignment regulating force of the liquid crystal compound of the linear polarizer.

[Lamination order of each layer]

The laminated optical film according to the embodiment of the present invention consists of a plurality of layers, and the order of the steps of laminating the plurality of layers is not particularly limited and can be optionally selected.

For example, in a case where a functional layer is transferred from a film consisting of a temporary support and a functional layer, wrinkles and cracks during the transfer can be prevented by adjusting the laminating order such that the thickness of the film at the transfer destination reaches 10 μm or more.

In addition, from the viewpoint of reducing the surface roughness Ra of the laminated optical film, in a case where another layer is laminated on a layer having large surface unevenness, the surface unevenness may be further amplified, and thus it is preferable that the layers are laminated in order from a layer having a smaller surface roughness Ra.

In addition, from the viewpoint of quality evaluation in the step of producing the laminated optical film, the laminating order can also be selected. For example, layers excluding the reflective circular polarizer may be laminated, the quality evaluation may be performed using a transmission optical system, the reflective circular polarizer may be laminated, and the quality evaluation may be performed using a reflection optical system.

In addition, from the viewpoint of improving the production yield of the laminated optical film and reducing the cost, it is also possible to select the laminating order.

[Applications of laminated optical film according to embodiment of present invention]

For example, as disclosed in JP2017-227720A and JP1995-120679A (JP-H7-120679A), the laminated optical film according to the embodiment of the present invention can be used as a reflective polarizer to be incorporated in an in-vehicle room mirror, a virtual reality display device, an electronic finder, and the like.

Particularly in a virtual reality display device, an electronic finder, or the like that has a reciprocating optical system allowing light to be reflected between the reflective polarizer and the half mirror to reciprocate the light, the laminated optical film according to the embodiment of the present invention is extremely useful from the viewpoint of improving the sharpness of a display image. In addition, since a virtual reality display device, an electronic finder, or the like that has a reciprocating optical system includes an optical film such as an absorption type polarizer or a circular polarizer in addition to the reflective polarizer in some cases, the sharpness of a display image can be further improved by applying some of the members and the bonding methods used for the laminated optical film according to the embodiment of the present invention to the optical film other than the reflective polarizer described above.

### <Molding Method>

The optical laminate and the laminated optical film according to the embodiment of the present invention may be used in a form of a flat surface or may be molded in a form of any shape and used. Here, the optical laminate and the laminated optical film are collectively referred to as an optical film, and a molding method will be described.

The method for molding an optical film includes a step of heating the optical film, a step of pressing the optical film against a mold and deforming the optical film along a shape of the mold, and a step of cutting the optical film.

[Step of heating optical film]

As a method of heating the optical film, heating by bringing a heated solid into contact, heating by bringing a heated liquid into contact, heating by bringing a heated gas into contact, heating by irradiating with infrared rays, heating by irradiating with microwaves, and the like can be used. However, the heating by irradiating with infrared rays is preferable because the optical film can be heated remotely immediately before the molding.

The wavelength of the infrared ray used for heating is preferably 1.0 to 30.0 μm, and more preferably 1.5 to 5 μm.

As the IR light source, a near-infrared lamp heater in which a tungsten filament is inserted into a quartz tube, a wavelength control heater in which a mechanism for cooling a part between quartz tubes with air is provided by multiplexing the quartz tubes, and the like can be used.

In addition, by imparting a temperature distribution in a plane of the optical film, it is possible to control a physical property value during molding according to the purpose.

As a method of imparting the temperature distribution, there are a method of imparting an irradiation amount distribution of infrared rays used for heating, a method of controlling the temperature distribution by an intensity distribution of cooling air, a method of controlling the temperature and contact time of the mold to control the progress of cooling by contact with the mold to impart the distribution, and the like. As a method of imparting infrared ray irradiation amount distribution, a method of varying the density of the arrangement of the IR light sources, or a method of placing a filter with a patterned transmittance to infrared light between the IR light sources and the optical film are used. As the filter in which the transmittance is patterned, a filter in which a metal is deposited on glass, a filter in which a cholesteric liquid crystal layer having a reflection band in an infrared region is provided, a filter in which a dielectric multi-layer film having a reflection band in an infrared region is provided, a filter obtained by applying an ink that absorbs infrared rays, and the like is used. The temperature of the optical film is controlled by the intensity of the infrared irradiation, the irradiation time of the infrared irradiation, the illuminance of the infrared irradiation, and the like.

The temperature of the optical film can be monitored using a temperature measuring means such as a non-contact radiation thermometer and a thermocouple, and the optical film can be molded at a target temperature.

[Step of pressing optical film against mold to deform optical film along shape of mold]

As a method of pressing the optical film against the mold and deforming the optical film along the shape of the mold, decompression and pressurization of the molding space are used. In addition, a method of pushing the mold can also be used.

[Step of cutting optical film]

As a method of cutting the molded optical film into any desired shape, a cutter, scissors, a cutting plotter, a laser cutting machine, or the like can be used.

<Molding device>

As one aspect of the molding device, a device is shown as an example, in which a box 1 having an opening portion in an upper direction and a box 2 having an opening portion in a lower direction are provided, the opening portion of the box 1 and the opening portion of the box 2 are fitted together directly or through other holding devices to form a sealed molding space.

A mold (also referred to as an adherend) having a molded shape and the film to be molded are arranged in the molding space. The film to be molded is used as a partition to divide the molding space which consists of the box 1 and the box 2 into two spaces. The mold is disposed on the box 1 side below the film to be molded. Furthermore, a vacuum molding device includes multiple heating elements arranged in a dispersed manner to heat the film to be molded. The heating element may be disposed within the molding space, or may be disposed outside the molding space to heat the film to be molded by irradiation through a transparent window.

<Optical article>

The optical article according to the embodiment of the present invention includes the optical laminate according to the embodiment of the present invention.

One form of the optical article according to the embodiment of the present invention includes a composite lens including a lens, and the optical laminate or the laminated optical film according to the embodiment of the present invention. A half mirror may be formed on one surface of the lens.

As the lens, a convex lens or a concave lens can be used. As the convex lens, a biconvex lens, a plano-convex lens, or a convex meniscus lens can be used. As the concave lens, a biconcave lens, a plano-concave lens, or a concave meniscus lens can be used. As the lens used in the condensing optical system, a convex meniscus lens and a concave meniscus lens are preferable, and a concave meniscus lens is more preferable from the viewpoint of further reducing aberrations.

As a forming material of the lens, a material transparent to visible light, such as glass, crystal, and plastic, can be used.

Since the birefringence of the lens causes unevenness and noise, it is preferable that the birefringence is small, and a material with no birefringence is more preferable. The laminated optical film according to the embodiment of the present invention used in the optical article according to the embodiment of the present invention may be a flat surface or a curved surface, but a curved surface is preferable from the viewpoint that distortion and aberration of an image are small.

Another form of the optical article according to the embodiment of the present invention includes a prism or a substrate, and the optical laminate according to the embodiment of the present invention or the laminated optical film according to the embodiment of the present invention.

Examples of a material for forming the prism and the substrate include glass, crystal, and plastic. These forming materials may be transparent or opaque to visible light. Since the birefringence of the prism and the substrate causes unevenness, noise, and the like, it is preferable that the birefringence is small, and a material in which the birefringence is zero is more preferable.

### EXAMPLES

Hereinafter, the features of the present invention will be described in more detail with reference to Examples. The materials, the used amounts, the ratios, the treatment contents, the treatment procedures, and the like described in Examples can be appropriately changed without departing from the gist of the present invention. In addition, configurations other than the configurations described below can be employed without departing from the gist of the present invention.

[Preparation of coating liquid for reflective layer]
<Coating liquid R-1 for reflective layer>

A composition shown below was stirred and dissolved in a container held at 70° C. to prepare a coating liquid R-1 for a reflective layer. Here, R represents a coating liquid containing a rod-like liquid crystal compound.

Coating liquid R-1 for reflective layer

| | |
|---|---|
| Methyl ethyl ketone | 120.9 parts by mass |
| Cyclohexanone | 21.3 parts by mass |
| Mixture X of rod-like liquid crystal | 100.0 parts by mass |
| compounds shown below | |
| Photopolymerization initiator B shown below | 1.00 part by mass |
| Chiral agent A shown below | 4.18 parts by mass |
| Surfactant F1 shown below | 0.1 parts by mass |

Mixture X of rod-like liquid crystal compounds

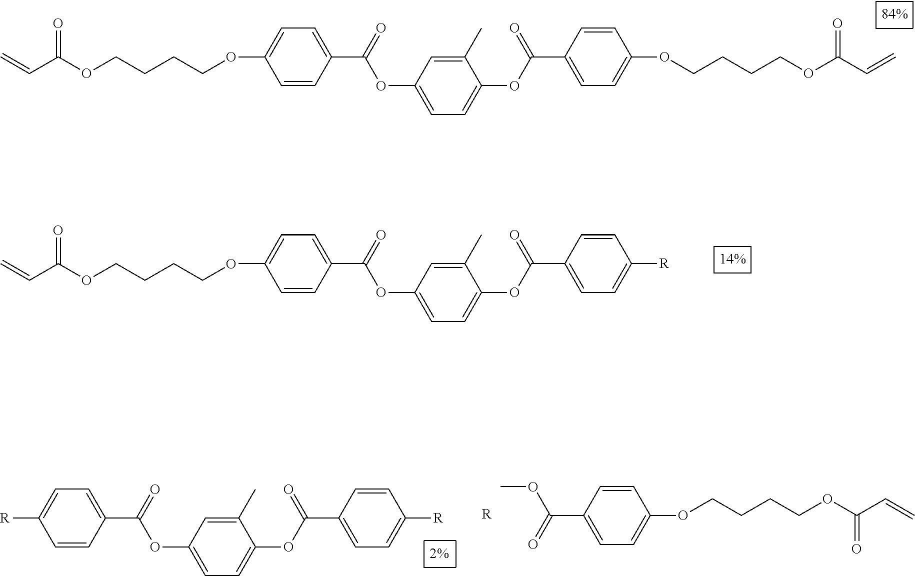

In the above-described mixture X, each numerical value denotes the content in units of % by mass. In addition, R represents a group bonded via an oxygen atom. Furthermore, an average molar absorption coefficient of the above-described rod-like liquid crystal compound at a wavelength of 300 to 400 nm was 140/mol·cm.

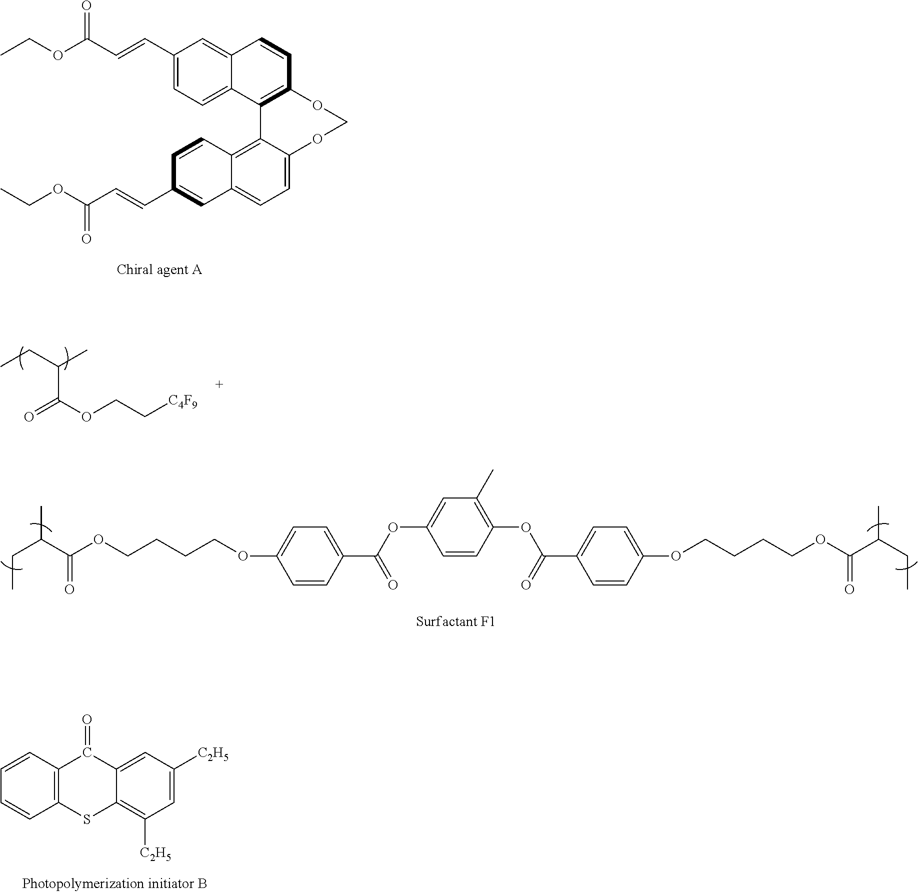

The chiral agent A is a chiral agent in which helical twisting power (HTP) is reduced by light.

<Coating liquid R-2 for reflective layer>

Coating liquids were prepared in the same manner as in the coating liquid R-1 for a reflective layer, except that the amount of the chiral agent A added was changed as shown in Table 1 below.

TABLE 1
Amount of chiral agent of coating liquid containing
rod-like liquid crystal compound

| | Amount of chiral |
|---|---|
| Name of coating | agent (parts by |
| liquid | mass) |
| Liquid R-1 | 4.18 |
| Liquid R-2 | 3.00 |

<Coating liquid D-1 for reflective layer>

A composition shown below was stirred and dissolved in a container held at 50° C. to prepare a coating liquid D-1 for a reflective layer. Here, D represents a coating liquid containing a disk-like liquid crystal compound.

Coating liquid D-1 for reflective layer

| | |
|---|---|
| Disk-like liquid crystal compound | 80 parts by mass |
| (A) shown below | |
| Disk-like liquid crystal compound | 20 parts by mass |
| (B) shown below | |
| Polymerizable monomer E1 shown below | 10 parts by mass |
| Surfactant F2 shown below | 0.3 parts by mass |
| Photopolymerization initiator (IRGACURE | 3 parts by mass |
| 907 manufactured by BASF SE) | |
| Chiral agent A shown above | 5.45 parts by mass |
| Methyl ethyl ketone | 290 parts by mass |
| Cyclohexanone | 50 parts by mass |

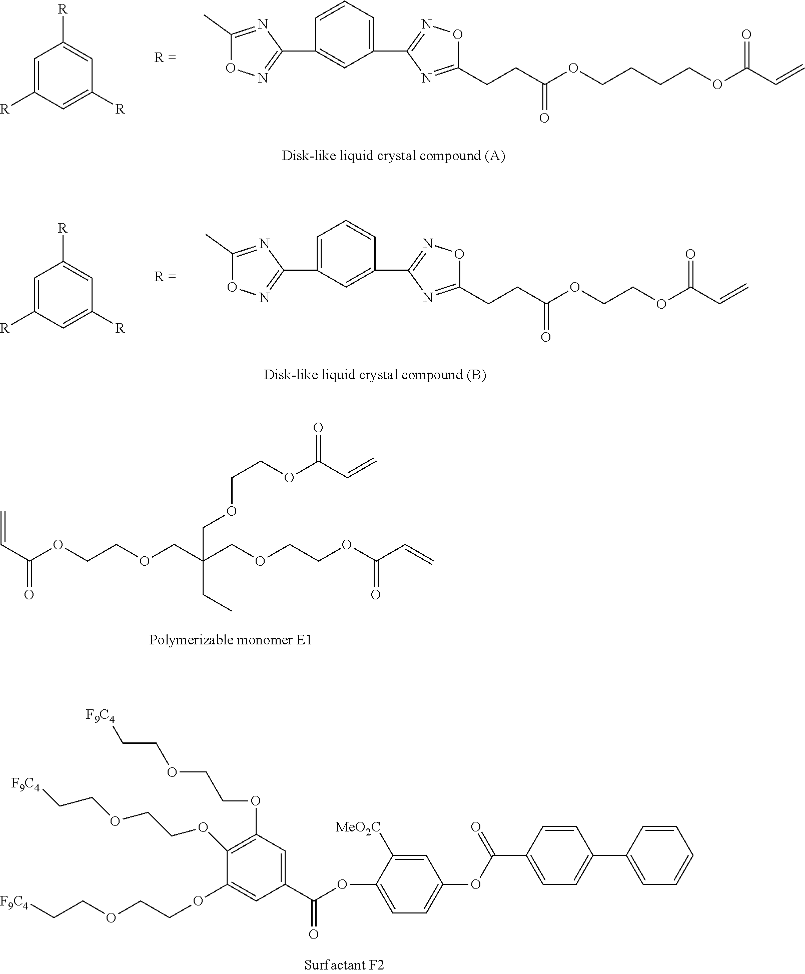

<Coating liquids D-2, D-3 for reflective layer>
Coating liquids were prepared in the same manner as in the coating liquid D-1 for a reflective layer, except that the amount of the chiral agent A added was changed as shown in Table 2 below.

TABLE 2
Amount of chiral agent of coating liquid containing
disk-like liquid crystal compound

| Name of coating | Amount of chiral agent |
|---|---|
| liquid | (parts by mass) |
| Liquid D-1 | 5.45 |
| Liquid D-2 | 4.52 |
| Liquid D-3 | 4.10 |

<Coating liquid PA-1 for light interference layer>

A composition shown below was stirred and dissolved in a container held at 60° C. to prepare a coating liquid PA-1 for a light interference layer.

Coating liquid PA-1 for light interference layer

| | |
|---|---|
| Methyl isobutyl ketone | 3011.0 parts by mass |
| Mixture X of rod-like liquid crystal | 100.0 parts by mass |
| compounds shown above | |
| Photopolymerization initiator C shown below | 5.1 parts by mass |
| Photoacid generator shown below | 3.0 parts by mass |
| Hydrophilic polymer shown below | 2.0 parts by mass |
| Vertical alignment agent shown below | 1.9 parts by mass |
| Viscosity reducing agent shown below | 4.2 parts by mass |
| Material for interlayer photo-alignment | 8.0 parts by mass |
| film shown below | |
| Stabilizer shown below | 0.2 parts by mass |

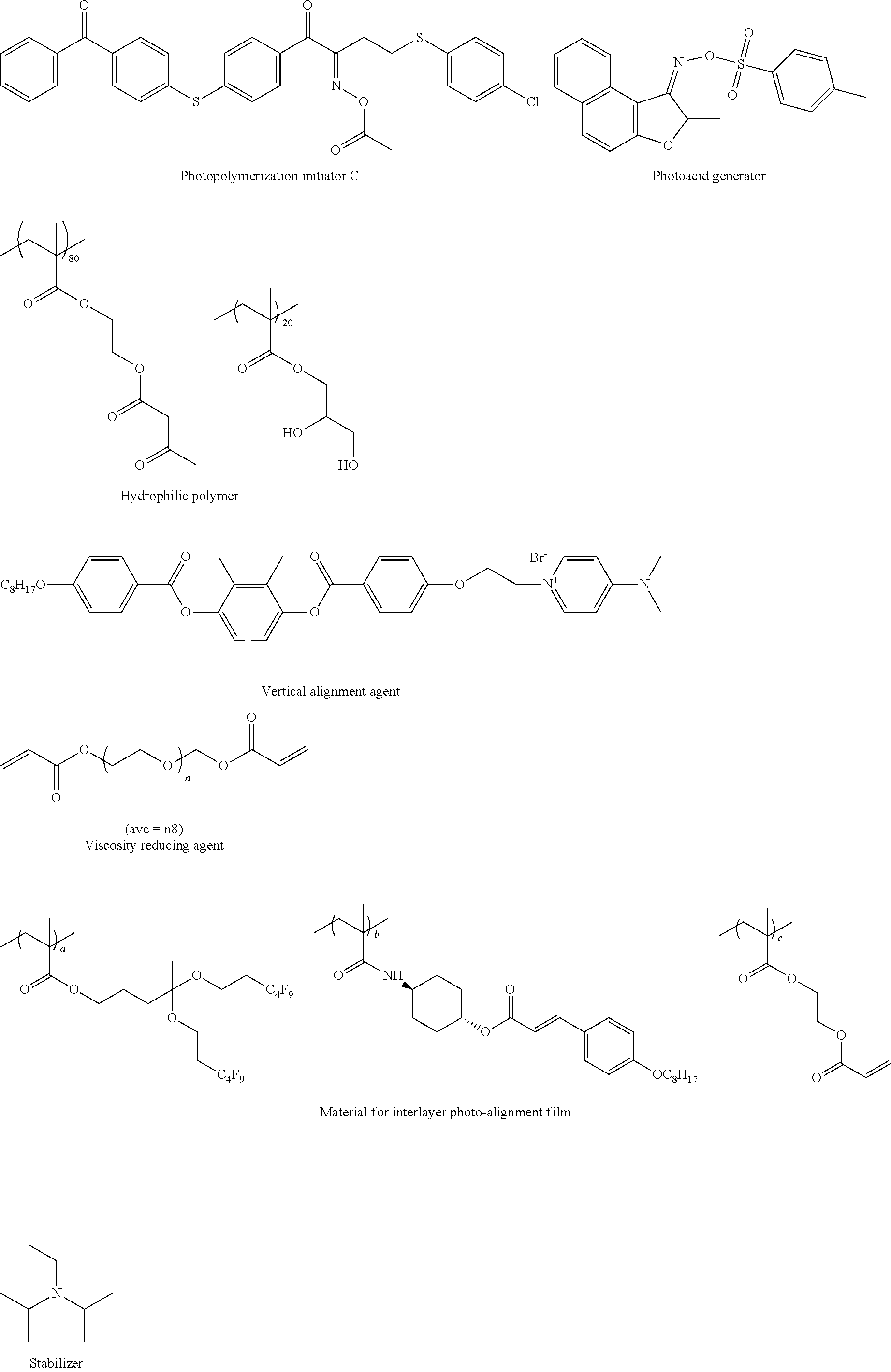

[Production of reflective circular polarizer 1]

As a temporary support, a triacetyl cellulose (TAC) film (manufactured by FUJIFILM Corporation, TG60) having a thickness of 60 μm was prepared.

The tack film shown above was coated with the coating liquid PA-1 for a light interference layer prepared above using a wire bar coater, and then dried at 80° C. for 60 seconds.

Thereafter, the liquid crystal compound was cured by irradiating the liquid crystal compound with light from an ultraviolet LED lamp (wavelength: 365 nm) with an irradiation amount of 300 mJ/cm² at 78° C. in a low oxygen atmosphere (100 ppm), and at the same time, a cleavage site of the material for an interlayer photo-alignment film was cleaved. Thereafter, the liquid crystal compound was heated at 115° C. for 25 seconds to eliminate a substituent containing a fluorine atom.

As a result, a positive C-plate layer, having a cinnamoyl group on the outermost surface and having a film thickness of 90 nm, was formed.

The refractive index nI at a wavelength of 550 nm measured with an interference film thickness meter OPTM (manufactured by Otsuka Electronics Co., Ltd., analyzed by least squares method) was 1.57. Rth(550) at a wavelength of 550 nm, which was measured with Axoscan (manufactured by Axometrics), was −9 nm.

Next, polarized UV light (wavelength: 313 nm) with an illuminance of 7 mW/cm² and an irradiation amount of 7.9 mJ/cm² was emitted from the positive C-plate side. The polarized UV light having a wavelength of 313 nm was obtained by transmitting ultraviolet light emitted from a mercury lamp through a band-pass filter having a transmission band at a wavelength of 313 nm and a wire grid polarizing plate.

The coating liquid R-1 for a reflective layer prepared as described above was applied using a wire bar coater, and dried at 110° C. for 72 seconds. Thereafter, the surface was irradiated with light using a metal halide lamp at 100° C., an illuminance of 80 mW/cm², and an irradiation amount of 500 mJ/cm² in a low oxygen atmosphere (100 ppm or less), thereby curing the coating liquid to form a first blue light reflecting layer (first light reflecting layer) consisting of a cholesteric liquid crystal layer.

The irradiation with light was performed from the side of the cholesteric liquid crystal layer in all cases. Here, the coating thickness was adjusted so that the film thickness of the cured first blue light reflecting layer was 2.6 μm.

Next, the surface of the first blue light reflecting layer was subjected to a corona treatment at a discharge amount of 150 W·min/m², and the surface subjected to the corona treatment was coated with the coating liquid D-1 for a reflective layer using a wire bar coater.

Subsequently, the coating film was dried at 70° C. for 2 minutes and heat-aged at 115° C. for 3 minutes after the solvent was vaporized, thereby obtaining a uniform alignment state. Thereafter, the coating film was kept at 45° C. and irradiated with ultraviolet rays (300 mJ/cm²) using a metal halide lamp in a nitrogen atmosphere, thereby curing the coating film to form a second blue light reflecting layer (second light reflecting layer) on the first blue light reflecting layer. The irradiation with light was performed from the side of the cholesteric liquid crystal layer in all cases. Here, the coating thickness was adjusted so that the film thickness of the cured second blue light reflecting layer was 2.0 μm.

Next, the second blue light reflecting layer was coated with the coating liquid D-2 for a reflective layer using a wire bar coater. Subsequently, the coating film was dried at 70° C. for 2 minutes and heat-aged at 115° C. for 3 minutes after the solvent was vaporized, thereby obtaining a uniform alignment state.

Thereafter, the coating film was kept at 45° C. and irradiated with ultraviolet rays (300 mJ/cm²) using a metal halide lamp in a nitrogen atmosphere, thereby curing the coating film to form a green light reflecting layer (third light reflecting layer) on the second blue light reflecting layer. The irradiation with light was performed from the side of the cholesteric liquid crystal layer in all cases. Here, the coating thickness was adjusted so that the film thickness of the cured green light reflecting layer was 2.7 μm.

Next, the green light reflecting layer was coated with the coating liquid R-2 for a reflective layer using a wire bar coater and dried at 110° C. for 72 seconds.

Thereafter, the surface was irradiated with light using a metal halide lamp at 100° C., an illuminance of 80 mW/cm², and an irradiation amount of 500 mJ/cm² in a low oxygen atmosphere (100 ppm or less), thereby curing the coating liquid to form a red light reflecting layer (fourth light reflecting layer) on the green light reflecting layer. The irradiation with light was performed from the side of the cholesteric liquid crystal layer in all cases. Here, the coating thickness was adjusted so that the film thickness of the cured red light reflecting layer was 3.4 μm.

Next, the surface of the red light reflecting layer was subjected to a corona treatment at a discharge amount of 150 W·min/m², and the surface subjected to the corona treatment was coated with the coating liquid D-3 for a reflective layer using a wire bar coater. Subsequently, the coating film was dried at 70° C. for 2 minutes and heat-aged at 115° C. for 3 minutes after the solvent was vaporized, thereby obtaining a uniform alignment state.

Thereafter, the coating film was kept at 45° C. and irradiated with ultraviolet rays (300 mJ/cm²) using a metal halide lamp in a nitrogen atmosphere, thereby curing the coating film to form a yellow light reflecting layer (fifth light reflecting layer) on the red light reflecting layer. The irradiation with light was performed from the side of the cholesteric liquid crystal layer in all cases. Here, the coating thickness was adjusted so that the film thickness of the cured yellow light reflecting layer was 3.4 μm.

Table 3 shows the reflection center wavelength and the film thickness of each of the reflective layers of the produced reflective circular polarizers 1. Here, the reflection center wavelength was used to define characteristics of a light reflection film having a reflection band formed of a cholesteric liquid crystal, and referred to the middle point of a spectral band reflected by the film. Specifically, the reflection center wavelength was obtained by calculating the average value of the wavelengths on the short wavelength side and the wavelengths on the long wavelength side which show the half value of the peak reflectivity. A reflection center wavelength (central wavelength of reflected light) was confirmed by producing a film obtained by applying only a single layer. The film thickness was obtained by SEM.

TABLE 3
Characteristics of light reflecting layer
of reflective circular polarizer

| | | | Film |
|---|---|---|---|
| | Type of | Reflection center | thickness |
| | coating liquid | wavelength (nm) | (μm) |
| 5th layer | Liquid D-3 | 586 | 3.4 |
| 4th layer | Liquid R-2 | 661 | 3.4 |
| 3rd layer | Liquid D-2 | 531 | 2.7 |
| 2nd layer | Liquid D-1 | 441 | 2.0 |
| 1st layer | Liquid R-1 | 475 | 2.6 |

[Preparation of reflective circular polarizers 2 to 5 and 7 to 15]

The reflective circular polarizers 2 to 5 and 7 to 15 were produced by the same production method as that of a reflective circular polarizer 1, except that the film thickness of the light interference layer was changed as shown in Table 4 below.

In addition, the reflective circular polarizer 6 having no light interference layer was prepared by preparing a reflective layer on the rubbed PET film under the same conditions as those for the reflective circular polarizer 1 without providing the light interference layer.

[Production of reflective circular polarizer 16]

The reflective circular polarizer 16 was produced by the same production method as that of the reflective circular polarizer 1, except that a photo-alignment layer was formed as a light interference layer by the following process.

<Formation of photo-alignment layer>

A coating liquid PA2 for forming an alignment layer, which will be described later, was continuously applied onto a triacetyl cellulose (TAC) film (manufactured by FUJIFILM Corporation, TG60) having a thickness of 60 μm using a wire bar. The support on which the coating film was formed was dried with hot air at 140° C. for 120 seconds, and subsequently, the coating film was irradiated with polarized ultraviolet rays (10 mJ/cm², using an ultra-high-pressure mercury lamp) to form a photo-alignment layer. The film thickness was 80 nm.

(Coating liquid PA2 for forming alignment layer)

| | | |
|---|---|---|
| Polymer M-PA-1 shown below | 100.00 | parts by mass |
| Acid generator PAG-1 shown below | 5.00 | parts by mass |
| Acid generator CPI-110TF shown below | 0.005 | parts by mass |
| Xylene | 3660.00 | parts by mass |
| Methyl isobutyl ketone | 366.00 | parts by mass |

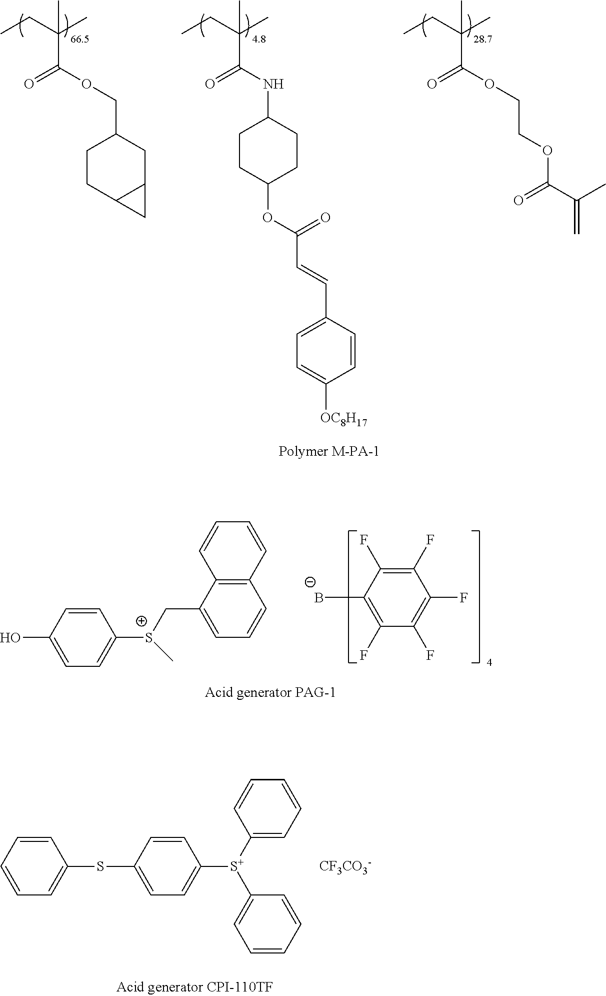

[Production of reflective circular polarizer 17]
[Preparation of coating liquid R-3 for reflective layer]

A composition shown below was stirred and dissolved in a container held at 70° C. to prepare a coating liquid R-3 for a reflective layer. Here, R represents a coating liquid containing a rod-like liquid crystal compound.

Coating liquid R-3 for reflective layer

| | | |
|---|---|---|
| Methyl ethyl ketone | 120.9 | parts by mass |
| Cyclohexanone | 21.3 | parts by mass |
| Rod-like liquid crystal | 100.0 | parts by mass |
| compound X-2 shown below | | |
| Photopolymerization initiator | 1.00 | part by mass |
| B shown above | | |
| Chiral agent A shown above | 4.18 | parts by mass |
| Surfactant F1 shown above | 0.1 | parts by mass |

### Rod-Like Liquid Crystal Compound X2

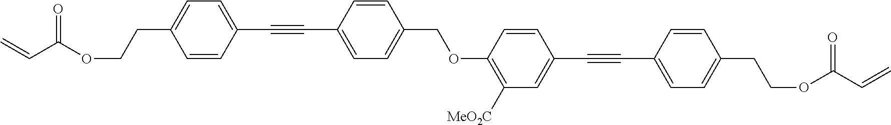 [SMILES: C=CC(=O)OCCc1ccc(C#Cc2ccc(COc3ccc(C#Cc4ccc(CCOC(=O)C=C)cc4)cc3C(=O)OC)cc2)cc1]

[Coating liquid R-4 for reflective layer]

A coating liquid R-4 for a reflective layer was prepared in the same manner as that of the coating liquid R-3 for a reflective layer, except that the addition amount of the chiral agent A was changed as shown in Table 4 described later.

TABLE 4

| | Amount of |
|---|---|
| Name of | chiral agent |
| coating liquid | (parts by mass) |
| Liquid R-3 | 4.35 |
| Liquid R-4 | 2.86 |

[Coating liquid D-4 for reflective layer]

The following composition was stirred and dissolved to prepare a coating liquid D-4 for a reflective layer. Here, D represents a coating liquid containing a disk-like liquid crystal compound.

Coating liquid D-4 for reflective layer

| | | |
|---|---|---|
| Disk-like liquid crystal compound | 100 | parts by mass |
| (C) shown below | | |
| Polymerizable monomer shown | 10 | parts by mass |
| above E1 | | |
| Surfactant F2 shown above | 0.3 | parts by mass |
| Photopolymerization initiator | 3 | parts by mass |
| (IRGACURE 907 manufactured | | |
| by BASF SE) | | |
| Chiral agent A shown above | 5.45 | parts by mass |
| Methylene chloride | 340 | parts by mass |

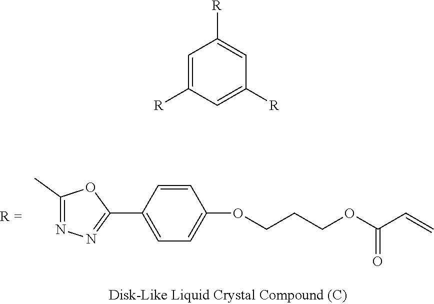

[Coating liquid D-5 for reflective layer and coating liquid D-6 for reflective layer]

A coating liquid D-5 for a reflective layer and a coating liquid D-6 for a reflective layer were prepared in the same manner as that in the coating liquid D-4 for a reflective layer, except that the addition amount of the chiral agent A was changed as shown in Table 5 below.

TABLE 5

| | Amount of |
|---|---|
| Name of | chiral agent |
| coating liquid | (parts by mass) |
| Liquid D-4 | 5.83 |
| Liquid D-5 | 4.65 |
| Liquid D-6 | 4.04 |

Using these coating liquids, the coating was performed on the rubbed PET film by the same method as that for the reflective polarizer 6, except that the film thickness after curing was adjusted to the value shown in Table 6, thereby preparing a reflective circular polarizer 17.

TABLE 6

| | | | Film |
|---|---|---|---|
| | Type of | Reflection center | thickness |
| | coating liquid | wavelength (nm) | (μm) |
| 5th layer | Liquid D-6 | 606 | 2.4 |
| 4th layer | Liquid R-4 | 706 | 1.9 |
| 3rd layer | Liquid D-5 | 526 | 2.3 |
| 2nd layer | Liquid D-4 | 420 | 1.4 |
| 1st layer | Liquid R-3 | 464 | 1.4 |

Characteristics of the produced reflective circular polarizers 1 to 17 are described in Table 7.

TABLE 7
Prepared reflective circular polarizers 1 to 17

| | Thickness | | |
|---|---|---|---|
| | of light | | |
| | interference | Refractive | |
| Reflective circular polarizer | layer (nm) | index | Rth(nm) |
| Reflective circular polarizer 1 | 90 | 1.57 | −9 |
| Reflective circular polarizer 2 | 80 | 1.57 | −8 |
| Reflective circular polarizer 3 | 100 | 1.57 | −10 |
| Reflective circular polarizer 4 | 270 | 1.57 | −27 |
| Reflective circular polarizer 5 | 180 | 1.57 | −18 |
| Reflective circular polarizer 6 | None | — | — |
| Reflective circular polarizer 7 | 50 | 1.57 | −5 |
| Reflective circular polarizer 8 | 60 | 1.57 | −6 |
| Reflective circular polarizer 9 | 70 | 1.57 | −7 |
| Reflective circular polarizer 10 | 110 | 1.57 | −11 |
| Reflective circular polarizer 11 | 120 | 1.57 | −12 |
| Reflective circular polarizer 12 | 210 | 1.57 | −21 |
| Reflective circular polarizer 13 | 230 | 1.57 | −23 |
| Reflective circular polarizer 14 | 330 | 1.57 | −33 |
| Reflective circular polarizer 15 | 350 | 1.57 | −35 |
| Reflective circular polarizer 16 | 80 | 1.56 | 0 |
| Reflective circular polarizer 17 | None | — | — |

[Production of laminated optical films 1 to 16]

A laminated optical film was produced by the following procedure.

<Production of retardation layer 1>

A retardation layer 1 having reverse dispersibility was produced with reference to the method described in paragraphs 0151 to 0163 of JP2020-084070A.

In the retardation layer 1, Re(550)=146 nm and Rth(550)=73 nm.

<Production of positive C-plate 2>

A positive C-plate 2 was produced by adjusting the film thickness with reference to the method described in paragraphs 0132 to 0134 of JP2016-053709A. Here, the support was changed from a polyethylene terephthalate film (PET film) to a triacetyl cellulose film (TAC film).

The positive C-plate 2 had Re(550)=0.1 nm and Rth(550)=−80 nm.

<Production of linear polarizer>

A linear polarizer was produced through the following procedure.

(Production of cellulose acylate film 1)
—Production of core layer cellulose acylate dope—

The following composition was put into a mixing tank and stirred to dissolve each component, thereby preparing a cellulose acetate solution used as a core layer cellulose acylate dope.

Core layer cellulose acylate dope

| | | |
|---|---|---|
| Cellulose acetate having acetyl | 100 | parts by mass |
| substitution degree of 2.88 | | |
| Polyester compound B described in | 12 | parts by mass |
| Examples of JP2015-227955A | | |
| Compound F shown below | 2 | parts by mass |
| Methylene chloride (first solvent) | 430 | parts by mass |
| Methanol (second solvent) | 64 | parts by mass |

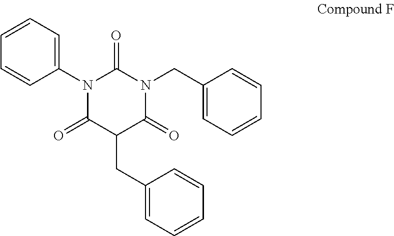 [SMILES: O=C1C(Cc2ccccc2)C(=O)N(c2ccccc2)C(=O)N1Cc1ccccc1]

—Production of outer layer cellulose acylate dope—

10 parts by mass of the following matte agent solution was added to 90 parts by mass of the core layer cellulose acylate dope to prepare a cellulose acetate solution to be used as an outer layer cellulose acylate dope.

Matting agent solution

| | | |
|---|---|---|
| Silica particles with average particle size of | 2 | parts by mass |
| 20 nm (AEROSIL R972, manufactured by | | |
| Nippon Aerosil Co., Ltd.) | | |
| Methylene chloride (first solvent) | 76 | parts by mass |
| Methanol (second solvent) | 11 | parts by mass |
| Core layer cellulose acylate dope | 1 | part by mass |
| shown above | | |

—Production of cellulose acylate film 1—

The core layer cellulose acylate dope and the outer layer cellulose acylate dope were filtered through filter paper having an average hole diameter of 34 μm and a sintered metal filter having an average pore size of 10 μm, and three layers which were the core layer cellulose acylate dope and the outer layer cellulose acylate dopes provided on both sides of the core layer cellulose acylate dope were simultaneously cast from a casting port onto a drum at 20° C. (band casting machine).

Next, the film was peeled off in a state where the solvent content was approximately 20% by mass, both ends of the film in the width direction were immobilized by tenter clips, and the film was dried while being stretched at a stretching ratio of 1.1 times in the lateral direction.

Thereafter, the film was further dried by being transported between the rolls of the heat treatment device to prepare an optical film having a thickness of 40 μm, and the optical film was used as a cellulose acylate film 1. The in-plane retardation of the obtained cellulose acylate film 1 was 0 nm.

<Formation of photo-alignment layer PA1>

The cellulose acylate film 1 was continuously coated with a coating liquid S-PA-1 for forming an alignment layer described below with a wire bar. The support on which the coating film was formed was dried with hot air at 140° C. for 120 seconds, and the coating film was irradiated with polarized ultraviolet rays (10 mJ/cm², using an ultra-high pressure mercury lamp) to form a photo-alignment layer PA1. A film thickness thereof was 0.3 μm.

(Coating liquid S-PA-1 for forming alignment layer)

| | | |
|---|---|---|
| Polymer M-PA-1 shown above | 100.00 | parts by mass |
| Acid generator PAG-1 shown above | 5.00 | parts by mass |
| Acid generator CPI-110TF shown above | 0.005 | parts by mass |
| Xylene | 1220.00 | parts by mass |
| Methyl isobutyl ketone | 122.00 | parts by mass |

<Formation of light absorption anisotropic layer P1>

The obtained alignment layer PA1 was continuously coated with the following coating liquid S—P-1 for forming a light absorption anisotropic layer with a wire bar.

Next, the coating layer P1 was heated at 140° C. for 30 seconds and cooled to room temperature (23° C.). Next, the coating layer P1 was heated at 90° C. for 60 seconds and cooled to room temperature again.

Thereafter, the coating layer P1 was irradiated with an LED lamp (central wavelength of 365 nm) for 2 seconds under an irradiation condition of illuminance of 200 mW/cm², thereby forming a light absorption anisotropic layer P1 on the alignment layer PA1. A film thickness thereof was 1.6 μm.

Composition of coating liquid S-P-1 for forming
light absorption anisotropic layer

| | | |
|---|---|---|
| Dichroic substance D-1 shown below | 0.25 | parts by mass |
| Dichroic substance D-2 shown below | 0.36 | parts by mass |
| Dichroic substance D-3 shown below | 0.59 | parts by mass |
| Polymer liquid crystal compound | 2.21 | parts by mass |
| M-P-1 shown below | | |
| Low-molecular-weight liquid crystal | 1.36 | parts by mass |
| compound M-1 shown below | | |
| Polymerization initiator IRGACURE | 0.200 | parts by mass |
| OXE-02 (manufactured by BASF SE) | | |
| Surfactant F-3 shown below | 0.026 | parts by mass |
| Cyclopentanone | 46.00 | parts by mass |
| Tetrahydrofuran | 46.00 | parts by mass |
| Benzyl alcohol | 3.00 | parts by mass |

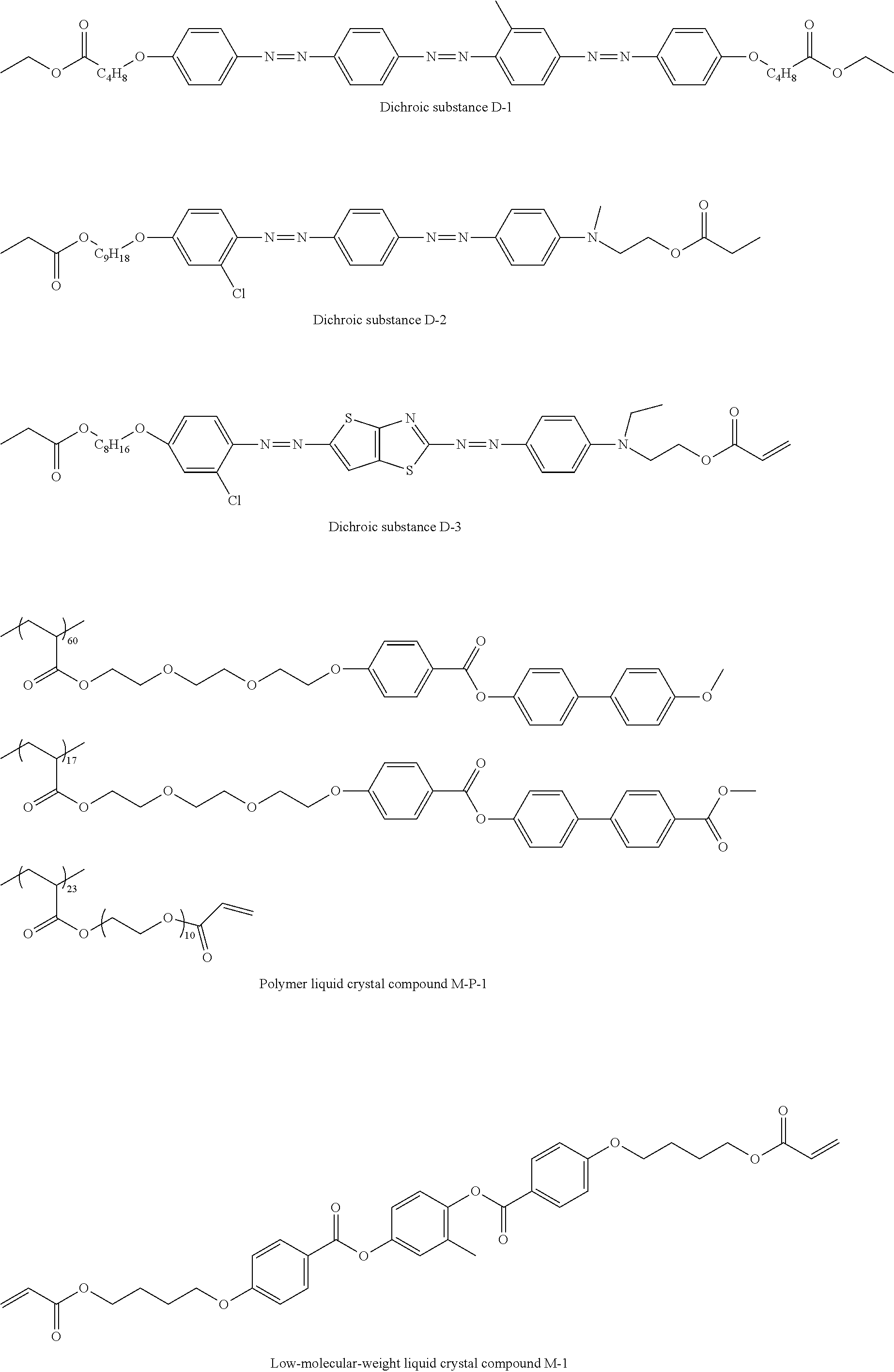

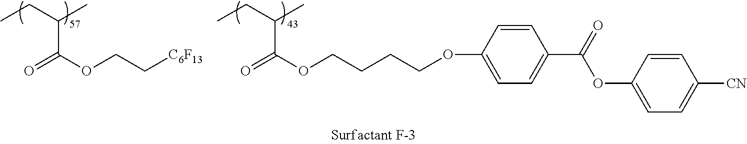

### <Transfer for Producing Laminated Optical Film>

The transfer for producing the laminated optical film was performed by the following procedure.
(1) A UV adhesive Chemi-seal U2084B (manufactured by ChemiTech Inc., refractive index n after curing n: 1.60) was applied onto the PMMA base material using a wire bar coater such that the thickness was set to 2 μm. The light absorption anisotropic layer P1 was transferred thereon. The light absorption anisotropic layer P1 was laminated with a laminator such that the side opposite to the temporary support was in contact with the UV adhesive.
(2) After nitrogen purging until the oxygen concentration reached 100 ppm or less in a purge box, the light absorption anisotropic layer P1 was cured by being irradiated with ultraviolet rays using a high-pressure mercury lamp from the temporary support side. The illuminance was 25 mW/cm² and the irradiation amount was 1,000 mJ/cm².
(3) Finally, the temporary support of the light absorption anisotropic layer P1 was peeled off.

Next, the retardation layer 1 was transferred to the light absorption anisotropic layer P1 by the same transfer procedure as described above. Here, the retardation layer 1 and the light absorption anisotropic layer P1 were laminated such that the slow axis of the retardation layer 1 and the absorption axis of the light absorption anisotropic layer P1 formed an angle of 45°. Next, the positive C-plate 2 was transferred to the retardation layer 1 by the same transfer procedure as described above.

Finally, the reflective circular polarizer 1 was transferred to the positive C-plate 2 by the same transfer procedure as described above. In this manner, a laminated optical film using the reflective circular polarizer 1 of Example 1 was obtained.

Reflective circular polarizers 2 to 16 were also produced in the same procedure to produce laminated optical films 2 to 16. In addition, a laminated optical film 23 was prepared using the same procedure as that of the reflective circular polarizer 17.

[Production of laminated optical film 17]

A hardcoat layer having a refractive index of 1.57 and a film thickness of 90 nm was formed on the surface of the laminated optical film 6 on the reflective circular polarizer 6 side by a coating method to form a light interference layer. Rth(550) of the hardcoat layer was 0 nm. The composition of the hardcoat layer coating liquid and the coating process will be described below.

(Coating liquid HC-1 for hardcoat layer)

| | | |
|---|---|---|
| Polymerizable compound 1 | 12 | parts by mass |
| (10-functional urethane acrylate | | |
| (UV-1700B manufactured by Nippon | | |
| Gohsei Chemical Co., Ltd.)) | | |
| Polymerizable compound 2 (Fluorene | 8 | parts by mass |
| compound (Ogsol EA0200, | | |
| manufactured by Osaka Gas | | |
| Chemicals Co., Ltd.)) | | |
| Photopolymerization initiator (Oxime | 0.5 | parts by mass |
| ester-based (IRGACURE OXE01, | | |
| manufactured by BASF Japan Ltd.)) | | |
| Methyl ethyl ketone | 800.00 | parts by mass |

The coating liquid HC-1 for a hardcoat layer, which was adjusted as described above, was applied onto the surface of the laminated optical film 6 on the reflective circular polarizer 6 side by a wire bar coater, and then dried at 80° C. for 60 seconds.

Thereafter, the polymerizable compound was cured by irradiation with light from an ultraviolet LED lamp (wavelength: 365 nm) at 78° C. and an irradiation amount of 300 mJ/cm² in a low oxygen atmosphere (100 ppm).

In this manner, a laminated optical film 17 having a light interference layer with film thickness of 90 nm and consisting of a hardcoat material on the outermost surface was produced.

[Production of laminated optical films 18 to 22]

A light interference layer was formed by the same production procedure as that of the laminated optical film 17. However, the refractive index of the hardcoat layer was changed by changing the ratio of the polymerizable compound 1 to the polymerizable compound 2 in the coating liquid HC-1 for a hardcoat layer.

A hardcoat layer having a refractive index of 1.55 and a film thickness of 90 nm was applied to a surface of the laminated optical film 6 on the reflective circular polarizer 6 side to obtain a laminated optical film 18. Similarly, a hardcoat layer having a refractive index of 1.53 and a film thickness of 90 nm was formed by a coating method to obtain a laminated optical film 19. Similarly, a hardcoat layer having a refractive index of 1.51 and a film thickness of 90 nm was formed by a coating method to obtain a laminated optical film 20. Similarly, a hardcoat layer having a refractive index of 1.56 and a film thickness of 90 nm was formed by a coating method to obtain a laminated optical film 21. Similarly, a hardcoat layer having a refractive index of 1.54 and a film thickness of 90 nm was formed by a coating method to obtain a laminated optical film 22. Rth(550) of all the hardcoat layers was 0 nm.

[Production of laminated optical film 24]

A hardcoat layer having a refractive index of 1.57 and a film thickness of 90 nm was formed on the surface of the laminated optical film 23 on the reflective circular polarizer 17 side by a coating method in the same production procedure as that of the laminated optical film 17, thereby obtaining a laminated optical film 24.

[Molding method]

The produced laminated optical film was molded into a curved shape.

The laminated optical film 1 was set in a molding device.

A molding space in the molding device consisted of the box 1 and the box 2, partitioned by the laminated optical film 1, and a convex meniscus lens LE1076-A (diameter: 2 inches, focal length: 100 mm, curvature radius on the concave side: 65 mm) manufactured by Thorlabs, Inc., which had been subjected to aluminum vapor deposition on the convex surface side, was disposed as a mold in the box 1 on the lower side of the laminated optical film 1, with the concave surface facing upward. In this case, the reflective circular polarizer side of the laminated optical film 1 was disposed to be the mold side.

In addition, a transparent window was installed on the upper part of the box 2 on the upper side of the laminated optical film 1, and an IR light source for heating the laminated optical film 1 was installed on the outside of the box 2.

A patterned infrared reflecting filter consisting of a cholesteric liquid crystal layer that reflects infrared ray having a wavelength of 2.2 μm to 3.0 μm with a reflectivity of about 50% was disposed between the IR light source and the laminated optical film 1. The pattern of the patterned infrared reflecting filter is donut-shaped, and is obtained by hollowing out a central portion of a circular infrared reflection filter having a diameter of 2 inches with a diameter of 1 inch. In this case, the center portion of the patterned infrared reflecting filter was disposed to be located at the center portion of the mold in a case of being viewed from directly above.

Next, each of the inside of box 1 and the inside of box 2 was evacuated to 0.1 atm or less by a vacuum pump.

Next, as a step of heating the laminated optical film 1, infrared rays were emitted, and the laminated optical film 1 was heated until the center portion was heated to 108° C. and the end part heated to 99° C. Since the glass transition temperature Tg of the PMMA film used as the support was 105° C., it was intended that the center portion would be more likely to stretch and the end part would be less likely to stretch during the molding.

Next, as a step of pressing the laminated optical film 1 against the mold to perform deformation along a shape of the mold, gas was allowed to flow into the above-described box 2 from a gas cylinder to pressurize the optical film to 300 kPa, and the laminated optical film 1 was pressed against the mold. Finally, the laminated optical film 1 was removed from the lens which is a mold. In this manner, a laminated optical film 1 molded into a curved surface was obtained.

The laminated optical films 2 to 22 and 24 were also molded into a curved surface by the same procedure.

[Evaluation of ghost]

### [Production of Virtual Reality Display Device]

A virtual reality display device “Huawei VR Glass” (manufactured by Huawei Technologies Co., Ltd.), which was a virtual reality display device for which a reciprocating optical system was employed, was disassembled, and all composite lenses were taken out.

A virtual reality display device of Example 1 was produced by incorporating a composite lens 1 to which the laminated optical film 1 had been bonded into the main body instead of the lens, in which the light absorption anisotropic layer P1 side of the laminated optical film 1 was installed between the composite lens 1 and the eye such that the light absorption anisotropic layer P1 side was on the eye side.

The laminated optical film 1 and the composite lens 1 were bonded to each other with a bonding agent (manufactured by Soken Chemical & Engineering Co., Ltd., SK2057) such that the light interference layer faced the composite lens 1. This bonding agent serves as an adhesive layer in the optical laminate according to the embodiment of the present invention.

In this case, the refractive index nA of the adhesive layer used in a case where the laminated optical film 1 (Example 1) was installed in the lens at a wavelength of 550 nm was 1.49, and the average refractive index nL of the light reflecting layer (corresponding to the reflection layer A (reflective layer A 21a)) at a wavelength of 550 nm was 1.63. The square root of the product of these values ((nA×nL)^{1/2}) was 1.56, and the difference in refractive index between the refractive index of the light interference layer and the refractive index nI (1.57) at a wavelength of 550 nm was 0.01.

In addition, the laminated optical films 2 to 20 and 24 were similarly bonded to the composite lens 1 and incorporated into the main body of the virtual reality display device to prepare virtual reality display devices of Examples 2 to 13 and 16 and Comparative Examples 1 to 7.

The laminated optical films 21 and 22 were similarly bonded to the composite lens 1 and incorporated into the main body of the virtual reality display device, except that the bonding agent was changed to a pressure sensitive adhesive (NCF-D692) manufactured by LINTEC Corporation, thereby producing virtual reality display devices of Examples 14 and 15.

Similarly in Examples 2 to 9, Example 11, Comparative Example 1, and Comparative Examples 3 to 6, the refractive index nI of the light interference layer at a wavelength of 550 nm was 1.57, and the difference in refractive index was 0.01.

In addition, in Example 10 (the reflective polarizer 16), the refractive index nI of the light interference layer at a wavelength of 550 nm was 1.56, and the difference in refractive index was 0.00.

In addition, the refractive index nI of the light interference layer of Example 12 at a wavelength of 550 nm was 1.55, and the difference in refractive index was 0.01. In addition, the refractive index nI of the light interference layer of Example 13 at a wavelength of 550 nm was 1.53, and the difference in refractive index was 0.03. On the other hand, in the light interference layer of Comparative Example 7, the refractive index nI at a wavelength of 550 nm was 1.51, and the difference in refractive index was 0.05.

The refractive index nA of the adhesive layer used in a case where the laminated optical film 21 (Example 14) was installed in the lens at a wavelength of 550 nm was 1.46, and the average refractive index nL of the light reflecting layer (corresponding to the reflection layer A (reflective layer A 21a)) at a wavelength of 550 nm was 1.63. The square root of the product of these values ((nA×nL)^{1/2}) was 1.54, and the difference in refractive index between the refractive index of the light interference layer and the refractive index nI (1.56) at a wavelength of 550 nm was 0.02. In addition, the refractive index nI of the light interference layer of Example 15 at a wavelength of 550 nm was 1.54, and the difference in refractive index was 0.00.

Further, the refractive index nA of the adhesive layer used in a case where the laminated optical film 24 (Example 16) was installed in the lens at a wavelength of 550 nm was 1.49, and the average refractive index nL of the light reflecting layer (corresponding to the reflection layer A (reflective layer A 21a)) at a wavelength of 550 nm was 1.66 (Δn was 0.225). The square root of the product of these values ((nA×nL)^{1/2}) was 1.57, and the difference in refractive index between the refractive index of the light interference layer and the refractive index nI (1.57) at a wavelength of 550 nm was 0.00.

The relationship between each of Examples and Comparative Examples and the reflective circular polarizer used and the laminated optical film used is shown in Table 8 below.

Here, the refractive index of the adhesive layer was measured with an interference film thickness meter OPTM (manufactured by Otsuka Electronics Co., Ltd., analyzed by least squares method). In addition, the average refractive index of the light reflecting layer was measured by the method described below.

First, the light reflecting layer adjacent to the adhesive layer was peeled off and acquired, and the cross section of the light reflecting layer was observed with an SEM to acquire the helical pitch P. The helical pitch P is two periods of the light and dark striped pattern appearing in the SEM image. Next, a reflection spectrum (ultraviolet-visible-near infrared spectrophotometer V-750, manufactured by JASCO Corporation) was measured, and a short wavelength side half-width wavelength M1 and a long wavelength side half-width wavelength λh of a reflection band of the light reflecting layer were acquired. By using the helical pitch P and the half-value wavelengths λl and λh, the refractive indices nl=λl/P and nh=λh/P of the light reflecting layer in two directions can be obtained. From this, the average refractive index nI of the light reflecting layer was obtained as nI=(nl+nh)/2.

### <Evaluation of Ghost>

In the produced virtual reality display device, a black-and-white checkered pattern was displayed on an image display panel, and ghost visibility was visually evaluated in terms of the following five stages.
A; ghost was not visual at all.
B; ghost was slightly visible, but not noticeable.
C; weak ghost was visible.
D; slightly strong ghost was visible.
E; strong ghost was visible.

The evaluation results are shown in Table 9.

As a result, in the virtual reality display devices of Examples 1 to 16, the ghost was at a level that was not noticeable or was weak over the entire region of the lens. On the other hand, in the virtual reality display devices of Comparative Examples 1 to 7, the light in the white display region was partially recognized as a ghost that was slightly stronger in the black display region of the checker pattern.

TABLE 8
Types of reflective circular polarizers
used in Examples and Comparative Examples

| | Reflective circular | Laminated optical |
|---|---|---|
| | polarizer to be used | film to be used |
| Example 1 | Reflective circular | Laminated |
| | polarizer 1 | optical film 1 |
| Example 2 | Reflective circular | Laminated |
| | polarizer 2 | optical film 2 |
| Example 3 | Reflective circular | Laminated |
| | polarizer 3 | optical film 3 |
| Example 4 | Reflective circular | Laminated |
| | polarizer 4 | optical film 4 |
| Comparative | Reflective circular | Laminated |
| Example 1 | polarizer 5 | optical film 5 |
| Comparative | Reflective circular | Laminated |
| Example 2 | polarizer 6 | optical film 6 |
| Comparative | Reflective circular | Laminated |
| Example 3 | polarizer 7 | optical film 7 |
| Example 5 | Reflective circular | Laminated |
| | polarizer 8 | optical film 8 |
| Example 6 | Reflective circular | Laminated |
| | polarizer 9 | optical film 9 |
| Example 7 | Reflective circular | Laminated |
| | polarizer 10 | optical film 10 |
| Comparative | Reflective circular | Laminated |
| Example 4 | polarizer 11 | optical film 11 |
| Comparative | Reflective circular | Laminated |
| Example 5 | polarizer 12 | optical film 12 |
| Example 8 | Reflective circular | Laminated |
| | polarizer 13 | optical film 13 |
| Example 9 | Reflective circular | Laminated |
| | polarizer 14 | optical film 14 |
| Comparative | Reflective circular | Laminated |
| Example 6 | polarizer 15 | optical film 15 |
| Example 10 | Reflective circular | Laminated |
| | polarizer 16 | optical film 16 |
| Example 11 | Reflective circular | Laminated |
| | polarizer 6 | optical film 17 |
| Example 12 | Reflective circular | Laminated |
| | polarizer 6 | optical film 18 |
| Example 13 | Reflective circular | Laminated |
| | polarizer 6 | optical film 19 |
| Comparative | Reflective circular | Laminated |
| Example 7 | polarizer 6 | optical film 20 |
| Example 14 | Reflective circular | Laminated |
| | polarizer 6 | optical film 21 |
| Example 15 | Reflective circular | Laminated |
| | polarizer 6 | optical film 22 |
| Example 16 | Reflective circular | Laminated |
| | polarizer 17 | optical film 24 |

TABLE 9
Evaluation results of ghost

| | Reflective circular | Laminated | Ghost |
|---|---|---|---|
| | polarizer | optical film | visibility |
| Example 1 | Reflective circular | Laminated | B |
| | polarizer 1 | optical film 1 | |
| Example 2 | Reflective circular | Laminated | C |
| | polarizer 2 | optical film 2 | |
| Example 3 | Reflective circular | Laminated | C |
| | polarizer 3 | optical film 3 | |
| Example 4 | Reflective circular | Laminated | C |
| | polarizer 4 | optical film 4 | |
| Comparative | Reflective circular | Laminated | D |
| Example 1 | polarizer 5 | optical film 5 | |
| Comparative | Reflective circular | Laminated | D |
| Example 2 | polarizer 6 | optical film 6 | |
| Comparative | Reflective circular | Laminated | D |
| Example 3 | polarizer 7 | optical film 7 | |
| Example 5 | Reflective circular | Laminated | C |
| | polarizer 8 | optical film 8 | |
| Example 6 | Reflective circular | Laminated | C |
| | polarizer 9 | optical film 9 | |
| Example 7 | Reflective circular | Laminated | C |
| | polarizer 10 | optical film 10 | |
| Comparative | Reflective circular | Laminated | D |
| Example 4 | polarizer 11 | optical film 11 | |
| Comparative | Reflective circular | Laminated | D |
| Example 5 | polarizer 12 | optical film 12 | |
| Example 8 | Reflective circular | Laminated | C |
| | polarizer 13 | optical film 13 | |
| Example 9 | Reflective circular | Laminated | C |
| | polarizer 14 | optical film 14 | |
| Comparative | Reflective circular | Laminated | D |
| Example 6 | polarizer 15 | optical film 15 | |
| Example 10 | Reflective circular | Laminated | B |
| | polarizer 16 | optical film 16 | |
| Example 11 | Reflective circular | Laminated | B |
| | polarizer 6 | optical film 17 | |
| Example 12 | Reflective circular | Laminated | B |
| | polarizer 6 | optical film 18 | |
| Example 13 | Reflective circular | Laminated | C |
| | polarizer 6 | optical film 19 | |
| Comparative | Reflective circular | Laminated | D |
| Example 7 | polarizer 6 | optical film 20 | |
| Example 14 | Reflective circular | Laminated | C |
| | polarizer 6 | optical film 21 | |
| Example 15 | Reflective circular | Laminated | B |
| | polarizer 6 | optical film 22 | |
| Example 16 | Reflective circular | Laminated | B |
| | polarizer 17 | optical film 24 | |

The present invention can be suitably used for a virtual reality display device, an electronic finder, and the like.

### EXPLANATION OF REFERENCES

10, 11: optical laminate
21a, 22a, 23a: reflective layer A
21b, 22b, 24b: reflective layer B
25: first laminated reflective layer
26: second laminated reflective layer
27: light interference layer
28: adhesive layer
100: laminated optical film
103: reflective circular polarizer
104: positive C-plate
105: retardation layer
106: linear polarizer
300: half mirror
400: circular polarizer
500: image display panel
1000: ray (ray forming virtual image)
2000: ray (ray forming ghost)

What is claimed is:

1. An optical laminate comprising:
an adhesive layer;
a light interference layer; and
two or more laminated reflective layers,
wherein the laminated reflective layer includes
one reflective layer A that includes at least one or more cholesteric liquid crystal layers formed of a first liquid crystal compound which substantially consists of a rod-like liquid crystal compound and that does not include a cholesteric liquid crystal layer formed of a second liquid crystal compound which substantially consists of a disk-like liquid crystal compound, and
one reflective layer B that includes at least one or more cholesteric liquid crystal layers formed of the second liquid crystal compound which substantially consists of a disk-like liquid crystal compound and that does not include a cholesteric liquid crystal layer formed of the first liquid crystal compound which substantially consists of a rod-like liquid crystal compound,
among the two or more laminated reflective layers, in a case where reflective layers A face each other in two laminated reflective layers adjacent to each other in a lamination direction, central wavelengths of reflected light of the reflective layers A included in the two adjacent laminated reflective layers are different from each other,
among the two or more laminated reflective layers, in a case where reflective layers B face each other in two laminated reflective layers adjacent to each other in the lamination direction, central wavelengths of reflected light of the reflective layers B included in the two adjacent laminated reflective layers are different from each other,
the adhesive layer, the light interference layer, and the laminated reflective layers are adjacent to each other in this order,
in a case where a refractive index of the adhesive layer is nA and an average refractive index of one adjacent to the light interference layer out of the reflective layer A and the reflective layer B in the laminated reflective layer is nL, a refractive index nI of the light interference layer satisfies (nA×nL)^{1/2}−0.03≤nI≤(nA×nL)^{1/2}+0.03, and
a film thickness of the light interference layer is 60 nm to 110 nm or 230 nm to 330 nm.

2. The optical laminate according to claim 1,
wherein the reflective layer A and the reflective layer B are alternately arranged in the lamination direction of the optical laminate.

3. The optical laminate according to claim 1,
wherein a total number of the laminated reflective layers is 20 or less.

4. The optical laminate according to claim 1,
wherein a reflectivity of the optical laminate to light having a wavelength of 400 to 700 nm is 40% or more and less than 50%.

5. The optical laminate according to claim 1,
wherein the laminated reflective layer is configured such that the one reflective layer A and the one reflective layer B are in direct contact with each other, or configured such that the one reflective layer A and the one reflective layer B are arranged with an adhesion layer between the reflective layer A and the reflective layer B.

6. The optical laminate according to claim 1,
wherein the light interference layer is a photo-alignment film.

7. The optical laminate according to claim 1,
wherein the light interference layer is a C-plate.

8. The optical laminate according to claim 7,
wherein a compound having a cinnamoyl group is present between the C-plate and the laminated reflective layer.

9. The optical laminate according to claim 1,
wherein the light interference layer is a hardcoat layer.

10. The optical laminate according to claim 1,
wherein the film thickness of the light interference layer is 75 nm to 100 nm or 245 nm to 300 nm.

11. The optical laminate according to claim 1,
wherein the film thickness of the light interference layer is 80 nm to 95 nm or 260 nm to 285 nm.

12. The optical laminate according to claim 7,
wherein a retardation Rth(550) of the C-plate at the wavelength 550 nm in a thickness direction is −30 to −5 nm.

13. A laminated optical film comprising, in the following order, at least:
a reflective circular polarizer;
a retardation layer which converts circularly polarized light into linearly polarized light; and
a linear polarizer,
wherein the reflective circular polarizer is the optical laminate according to claim 1.

14. The laminated optical film according to claim 13,
wherein the linear polarizer includes a light absorption anisotropic layer which contains at least a liquid crystal compound and a dichroic substance.

15. The laminated optical film according to claim 13, further comprising:
a positive C-plate.

16. The laminated optical film according to claim 13, further comprising:
an antireflection layer on a surface.

17. The laminated optical film according to claim 16,
wherein the antireflection layer is a moth-eye film or an AR film.

18. The laminated optical film according to claim 13, further comprising:
a resin base material having a peak temperature of a loss tangent tan δ of 170° C. or lower.

19. An optical article comprising:
the optical laminate according to claim 1.

20. A virtual reality display device comprising:
the optical article according to claim 19.
